(19) United States
(12) Patent Application Publication
(10) Pub. No.: US 2024/0013213 A1
(43) Pub. Date: Jan. 11, 2024

(54) BLOCKCHAIN

(71) Applicant: Stanislav TROCK, Givat Shmuel (IL)

(72) Inventor: Stanislav TROCK, Givat Shmuel (IL)

(21) Appl. No.: 18/039,523

(22) PCT Filed: Dec. 2, 2021
(86) PCT No.: PCT/IB2021/061267

§ 371 Date: May 31, 2023

Related U.S. Application Data
(60) Provisional application No. 63/120,490, filed on Dec. 2, 2020.
(60) Provisional application No. 63/196,261, filed on Jun. 3, 2021.

(51) Int. Cl. G06Q 20/40; G06Q 20/38

(52) U.S. Cl. CPC G06Q 20/401; G06Q 20/389; G06Q 20/3829

(57) ABSTRACT

There is described a computer-implemented method of outputting a transmission to a second node of an unspent transaction output (UTXO) based blockchain, the method being performed by a first node of the blockchain, the method comprising: identifying an input of a transaction; identifying a locking script associated with an output of a previous transaction that is referenced by the input, wherein the locking script comprises a persisting smart contract that is arranged to persist through multiple transactions on the blockchain; and outputting a transmission to the second node in dependence on: the persisting smart contract being present in a locking script of an output of the transaction; and/or a redemption condition of the persisting smart contract being satisfied; wherein the persisting smart contract comprises a token identifier; and wherein the token identifier is associated with a contract transaction, which contract transaction is associated with the persisting smart contract, wherein the contract transaction defines the redemption condition.

### FIELD OF INVENTION

The present invention relates to a computer-implemented method of outputting a transmission to a node of an unspent transaction output (UTXO) based blockchain. Additionally, the invention further relates to a method of configuring a UTXO based blockchain, a method of validating a transaction of a UTXO blockchain, and an apparatus and system for using a UTXO based blockchain.

### BACKGROUND

Conventionally, unspent transaction output (UTXO) based blockchains, such as Bitcoin, have been considered to lack the ability to carry forward conditions/states from the output of a first transaction into the output of a subsequent transaction. In order to implement the carrying forward of conditions, account model blockchains, such as Ethereum have typically been used.

The present disclosure relates to methods of configuring and using UTXO based blockchains that carry forward conditions/states through series of UTXOs.

### SUMMARY OF THE DISCLOSURE

### Authenticity Verification

According to an aspect of the present disclosure, there is described a computer-implemented method of outputting a transmission to a second node of an unspent transaction output (UTXO) based blockchain, the method being performed by a first node of the blockchain, the method comprising: identifying an input of a transaction; identifying a locking script associated with an output of a previous transaction that is referenced by the input, wherein the locking script comprises a persisting smart contract that is arranged to persist through multiple transactions on the blockchain; and outputting a transmission to the second node in dependence on: the persisting smart contract being present in a locking script of an output of the transaction; and/or a redemption condition of the persisting smart contract being satisfied; wherein the persisting smart contract comprises a token identifier; and wherein the token identifier is associated with a contract transaction, which contract transaction is associated with the persisting smart contract, wherein the contract transaction defines the redemption condition.

Preferably, the contract transaction is a parent transaction of an issuing transaction. Preferably, the identifier comprises a public key and/or an address associated with a locking script of a UTXO that is spent by the issuing transaction.

Preferably, the token identifier comprises a public key and/or an address from the contract transaction and/or an/the issuing transaction. Preferably, the token identifier comprises an address from a locking script of the contract transaction.

Preferably, the token identifier comprises a public key and/or an address associated with an issuer. Preferably, the issuer holds a private key relating to the token identifier.

Preferably, the token identifier comprises a public key and/or public address associated with a locking script of a UTXO that is spent by the issuing transaction.

Preferably, the token identifier comprises an immutable identifier.

Preferably, the locking script requires the presence of the persisting smart contract in an output of the transaction unless the redemption condition is satisfied.

Preferably, the persisting smart contract restricts a usage of a UTXO and/or token associated with the persisting smart contract.

Preferably, the contract transaction and/or the persisting smart contract: limits the use of a token associated with the locking script (e.g. a substantiated token associated with the locking script and/or the persistent smart contract); defines a redemption address and/or a redemption public key, preferably wherein the presence of the redemption address and/or the redemption public key in a locking script of an output of the transaction satisfies the redemption condition of the persisting smart contract (e.g. so that the persisting smart contract need not be replicated in said locking script of the output); defines a value (e.g. an amount) and/or representation of the token, preferably wherein the contract transaction defines a value and/or representation of the token that is associated with an asset that is external to the blockchain, more preferably wherein the contract transaction defines a value and/or representation of the token that is associated with a physical and/or digital asset.

Preferably, the method comprises determining a parameter of the transaction; and outputting the transmission in dependence on the parameter.

Preferably, the contract transaction and/or a/the redemption address is associated with an issuer of a/the substantiated token.

Preferably, the contract transaction defines an issuance contract. Preferably, the issuance contract defines requirements and/or conditions for the spending of the token.

Preferably, the issuance contract comprises one or more of: unencrypted (e.g. open) information, partially encrypted information, and encrypted information.

Preferably, an output of the contract transaction comprises a spendable data output and/or wherein an output of the contract transaction comprises an operation code that marks a transaction output execution termination, wherein this transaction output comprises a/the issuance contract (e.g. in ASCII code) and/or a reference to a/the issuance contract (e.g. a reference to a/the issuance contract on the blockchain). Preferably, said operation code is an OP_RETURN operation code (e.g. followed by the issuance contract text).

Preferably, the contract transaction references a single token of the blockchain. Preferably, the single token is indivisible.

Preferably, the contract transaction references a plurality of tokens of the blockchain. Preferably, each token is indivisible.

Preferably, the transaction and/or the previous transaction comprises a pointer to a/the contract transaction and/or a pointer to a/the issuance contract.

Preferably, the token identifier comprises one or more of: an identifier of an issuer of a substantiated token; and a public key and/or an address associated with an issuer of a substantiated token.

Preferably, the locking script requires as an unlocking condition that the persisting smart contract is replicated in an output of the transaction, preferably an output corresponding to the input (e.g. so that the output and the input form an input-output pair).

Preferably, the locking script requires as an unlocking condition that a redemption condition set by a/the contract transaction is satisfied.

Preferably, the locking script requires as an unlocking condition either that: the persisting smart contract is replicated in an output of the transaction; or a redemption condition set by a/the contract transaction is satisfied.

Preferably, the method comprises identifying an ownership indicator associated with the persisting smart contract.

Preferably, the transaction defines a change in ownership of a token associated with the persisting smart contract. Preferably, the persisting smart contract comprises an ownership indicator and the transaction defines a change in the ownership indicator.

Preferably, the method comprises determining a first ownership indicator associated with the persisting smart contract of the output of the previous transaction and determining a second ownership indicator associated with a similar (and/or identical) persisting smart contract of an output of the transaction, preferably outputting a transmission in dependence on the first ownership indicator and/or the second ownership indicator, more preferably outputting the second ownership indicator.

Preferably, the persisting smart contract is associated with and/or comprises and/or defines a value and/or an asset.

### Preservation of Token Amounts

Preferably, the locking script and/or the persisting smart contract requires as an unlocking condition that the value of the outputs spent through the inputs of the transaction is equal to the value of the outputs of the transaction.

Preferably, the method comprises comparing the value of the outputs spent through the inputs of the transaction to the value of the outputs of the transaction. Preferably, the method comprises outputting a transmission to a second node in dependence on the comparison. Preferably, the method comprises outputting a transmission to the second node in dependence on the value of the outputs spent through the inputs of the transaction being equal to the value of the outputs.

According to another aspect of the present disclosure, there is described a computer-implemented method of outputting a transmission to a second node of an unspent transaction output (UTXO) based blockchain, the method being performed by a first node of the blockchain, the method comprising: identifying an input of a transaction; identifying a locking script associated with an output of a previous transaction that is referenced by the input, wherein the locking script comprises a persisting smart contract that is arranged to persist through multiple transactions on the blockchain;

comparing the value of the outputs spent through the inputs of the transaction to the value of the outputs of the transaction; and outputting a transmission to a second node in dependence on the comparison, preferably outputting a transmission to the second node in dependence on the value of the outputs spent through the inputs of the transaction being equal to the value of the outputs.

Preferably, the method comprises comparing the value of the outputs spent through the inputs of (e.g. only) those transactions associated with the persisting smart contract to the value of the outputs of (e.g. only) those transaction associated with the persisting smart contract;

Preferably, identifying the input comprises identifying an input with a predetermined index, preferably identifying an input with an index of zero.

Preferably, the method comprises determining that only a single input of the transaction references an output of a previous transaction that is associated with a locking script comprising the persisting smart contract.

### Single Input

Preferably, the method comprises determining an index of said single input of the transaction. Preferably, the method comprises outputting a transmission to the second node in dependence on the index having a predetermined value.

According to another aspect of the present disclosure, there is described a computer-implemented method of outputting a transmission to a second node of an unspent transaction output (UTXO) based blockchain, the method being performed by a first node of the blockchain, the method comprising: identifying an input of a transaction; identifying a locking script associated with an output of a previous transaction that is referenced by the input, wherein the locking script comprises a persisting smart contract that is arranged to persist through multiple transactions on the blockchain; determining that only a single input of the transaction references an output of a previous transaction that is associated with a locking script comprising the persisting smart contract; and outputting a transmission to the second node in dependence on there being only a single input of the transaction that references an output of a previous transaction that is associated with a locking script comprising the persisting smart contract.

Preferably, the method comprises determining an index of said single input of the transaction. Preferably, the method comprises outputting a transmission to the second node in dependence on the index having a predetermined value.

Preferably, outputting a transmission to a second node in dependence on the index having a predetermined value comprises outputting a transmission to a second node in dependence on the single input being having an index value of zero.

Preferably, the method comprises determining a redemption condition associated with the persisting smart contract. Preferably, the method comprises determining the redemption condition from a contract transaction associated with the persisting smart contract.

Preferably, the method comprises determining that the unlocking script satisfies the redemption condition, and redeeming the token, and/or identifying that an output that does not comprise the persisting smart contract, in dependence on the satisfying of the redemption condition.

Preferably, the method comprises the persisting smart contract comprises one or more of: an indication of ownership (e.g. a ‘variable part’ for ownership relay); a self-replicating locking requirement (e.g. an OP_PUSH_TX) code; and a self-replicating smart contract logic (e.g. substantiated token contract own logic).

Preferably, the method comprises the persisting smart contract comprises one or more of: a variable code part, preferably wherein the variable code part indicates an owner of a token and/or a UTXO of a token associated with the persisting smart contract; a constant code part, preferably wherein the constant code part is required to ensure that the persisting smart contract is replicated, preferably replicated in an unmodified form; and a data part, preferably wherein the data part comprises the token identifier.

### Atomic Swaps

Preferably, the method comprises determining a reference in the transaction to an exchange of assets.

Preferably, the exchange of assets is associated with the exchange of an asset referenced in a first input of the transaction for an asset referenced in a second input of the transaction.

Preferably, the method comprises: identifying a persisting smart contract associated with a first input of the transaction; and identifying a locking script comprising a similar (and/or an equivalent and/or the same) persisting smart contract in a second output of the transaction.

Preferably, the method comprises outputting a transmission in dependence on the presence of the locking script.

Preferably, the first input corresponds to a first output, and a second input corresponds to the second output, preferably wherein the outputs spent through the first input are associated with the first output and/or wherein the outputs spent through the second input are associated with the second output.

According to another aspect of the present disclosure, there is described a computer-implemented method of outputting a transmission to a second node of an unspent transaction output (UTXO) based blockchain, the method being performed by a first node of the blockchain, the method comprising: identifying a first input and a second input of the transaction; identifying a first output and a second output of the transaction, wherein the first output corresponds to the first input and the second output corresponds to the second input; identifying a persisting smart contract associated with the first input of the transaction; and identifying a locking script comprising a similar persisting smart contract in the second output of the transaction; and outputting a transmission in dependence on the presence of the locking script.

Preferably, the first input of the transaction and/or the second input of the transaction comprises an offer of an exchange of assets.

Preferably, the first input and the second input relate to different types of assets.

Preferably, the first input and the second input are each associated with a different persisting smart contract. Preferably, the different persisting smart contracts have different token identifiers and/or the different persisting smart contracts relate to different assets.

Preferably, the first input and the second input are associated with the same type of persisting smart contracts. Preferably, the persisting smart contracts comprise a same constant code part and a different token identifier.

Preferably, the method comprises: identifying a second persisting smart contract associated with the second input of the transaction; and identifying a locking script comprising a persisting smart contract similar to the second persisting smart contract in the first output of the transaction; and outputting a transmission in dependence on the presence of the locking script in the first output.

Preferably, the method comprises determining a type of exchange associated with the transaction. Preferably, the method comprises determining whether the exchange relates to an exchange of substantiated tokens or to an exchange of unsubstantiated tokens.

Preferably, the method comprises determining that the first input and/or the first output has been signed by a first party, preferably using one or more of: a flag that signs a single input and a single output of the transaction, preferably that leaves the other inputs and outputs modifiable (e.g. a SINGLE|ANYONECAN PAY flag); a flag that signs all of the inputs and outputs of the transaction (e.g. an ALL flag).

Preferably, the method comprises determining that the first input and/or the first output has been signed by a first party (e.g. using a SINGLE|ANYONECAN PAY flag and/or an ALL flag).

Preferably, the method comprises determining that the second input and/or the second output have been signed by a second party and/or determining that all the inputs and/or outputs of the transaction have been signed by the second party (e.g. using an ALL flag).

Preferably, the method comprises: identifying a transaction comprising: a first input that references an output of a previous transaction, which output comprises a locking script that comprises a persisting smart contract, which persisting smart contract that is arranged to persist through multiple transactions on the blockchain; a second input; a first output associated with the first input so as to form an input-output pair; and a second output associated with the second input so as to form an input-output pair; determining that the first input and the first output have been signed by a first party (e.g. using a SINGLE|ANYONECAN PAY flag); determining that the second input and the second output have been signed by a second party (e.g. using an ALL flag); determining the presence of a locking script in the second output, which locking script comprises a persisting smart contract that is similar to the persisting smart contract in the locking script of the previous transaction; and outputting a transmission to the second node in dependence on the presence of the locking script.

According to another aspect of the present disclosure, there is described a computer-implemented method of outputting a transmission to a second node of an unspent transaction output (UTXO) based blockchain, the method being performed by a first node of the blockchain, the method comprising: identifying a transaction comprising: a first input that references an output of a previous transaction, which output comprises a locking script that comprises a persisting smart contract, which persisting smart contract that is arranged to persist through multiple transactions on the blockchain; a second input; a first output associated with the first input so as to form an input-output pair; and a second output associated with the second input so as to form an input-output pair; determining that the first output has been signed by a first party (e.g. using a SINGLE|ANYONECAN PAY flag); determining that the second input and the second output have been signed by a second party (e.g. using an ALL flag); determining the presence of a locking script in the second output, which locking script comprises a persisting smart contract that is similar to the persisting smart contract in the locking script of the previous transaction; and outputting a transmission to the second node in dependence on the presence of the locking script.

Preferably, the method comprises: identifying a plurality of inputs of the transaction, wherein the plurality of inputs relate to different bids for an asset associated with the first input; determining that one of the inputs has been signed by the first party.

Preferably, the method comprises determining that the transaction is associated with an earliest acceptance time (e.g. a nLocktime) in the future. Preferably, the earliest acceptance time relates to a timestamp and/or to a block height.

Preferably, the method comprises determining that a sequence number (e.g. nSequence) of an input of the transaction, preferably the first input, is less than a maximum sequence number (e.g. 0xFFFFFFFF).

Preferably, the method comprises determining that a sequence number (e.g. nSequence) of an input of the transaction is greater than a sequence number of an input of an earlier, similar, transaction.

Preferably, a value associated with said input is greater than a value associated with said earlier input.

Preferably, the second input is associated with an second unlocking script and wherein the second unlocking script relates to a second locking script of an output of a previous transaction, wherein the second locking script comprises a second persisting smart contract that is arranged to persist through multiple transactions on the blockchain; and wherein the method comprises determining the presence of a locking script in the first output, which locking script comprises a persisting smart contract that is similar to the second persisting smart contract in the locking script of the previous transaction.

According to another aspect of the present disclosure there is described a computer-implemented method of outputting a transmission to a second party, the method being performed by a first party, the method comprising: forming a partial transaction of an unspent transaction output (UTXO) based blockchain, wherein the partial transaction comprises a first input and a first output, wherein the first input and the first output form an input-output pair; wherein the first input references an output of a previous transaction, wherein the locking script of the output comprises a persisting smart contract that is arranged to persist through multiple transactions on the blockchain; and transmitting the partial transaction to the second party.

Preferably, the method comprises signing the first input and/or the first output of the partial transaction, preferably using one or more of: a flag that signs a single input and a single output of the transaction, preferably that leaves the other inputs and outputs modifiable (e.g. a SINGLE|ANYONECAN PAY flag); and a flag that signs all of the inputs and outputs of the transaction (e.g. an ALL flag).

Preferably, the method comprises transmitting the partial transaction without signing the first input and/or the first output of the partial transaction.

Preferably, the partial transaction is associated with an earliest acceptance time (e.g. a nLocktime) in the future, preferably wherein the earliest acceptance time relates to a timestamp and/or to a block height.

Preferably, the method comprises receiving and/or identifying a plurality of further transactions, wherein each transaction comprises a second input and a second output, wherein the second input and the second output form an input-output pair, preferably wherein each of the further transactions is associated with a different offer for an asset associated with the first input.

Preferably, the method comprises transmitting a further partial transaction to the second party, wherein the further partial transaction is similar to the partial transaction, and wherein the first input of the further partial transaction has a sequence number that is greater than a sequence number of the first input of the partial transaction.

Preferably, the method comprises signing the first input and/or the first output of a single one of the plurality of further transactions so as to accept the associated offer.

Preferably, the method comprises receiving and/or identifying a further transaction that comprises the first input and the first output, wherein the further transaction comprises a second input and a second output, wherein the second input and the second output form an input-output pair. Preferably, the second input and the second output of the further transaction are signed using a flag that signs all of the inputs and outputs of the transaction (e.g. an ALL flag).

Preferably, the method comprises signing the first input and/or the first output of the transaction, preferably using a flag that signs all of the inputs and outputs of the transaction (e.g. an ALL flag); and transmitting the transaction to the second party.

Preferably, the method comprises providing a locking script in the second output, which locking script comprises a persisting smart contract that is similar to (and/or the same as) the persisting smart contract in the locking script of the output of the previous transaction.

Preferably, the issuing transaction and/or the contract transaction is present in a previous block of the blockchain, preferably a block that is at least 5 blocks deep, 10 blocks deep, and/or 100 blocks deep.

Preferably, the persisting smart contract persists through at least 5 transaction, at least 10 transactions, and/or at least 100 transactions.

Preferably, outputting a transmission comprises one or more of: validating a transaction and/or a block of the blockchain; validating the transaction; proposing a transaction and/or a block for addition to the blockchain; propagating a transaction and/or a block of the blockchain through the nodes of the blockchain; indicating to the second node that the transaction and/or a block comprising the transaction is valid; and transmitting the transaction to the second node.

Preferably, the blockchain comprises a Bitcoin-based blockchain, e.g. BSV.

According to another aspect of the present disclosure, there is described a computer-implemented method of outputting a transmission to a second node of an unspent transaction output (UTXO) based blockchain, the method being performed by a first node of the blockchain, the method comprising: identifying an input of a transaction; identifying a locking script associated with an output of a previous transaction that is referenced by the input, wherein the locking script comprises a persisting smart contract that is arranged to persist through multiple transactions on the blockchain; determining a token identifier that forms a part of the persisting smart contract; determining an issuing transaction that is associated with the persisting smart contract; comparing the token identifier to a variable of the issuing transaction; and outputting a transmission to the second node in dependence on the comparison.

According to another aspect of the present disclosure, there is described a computer-implemented method of outputting a transaction to a node of an unspent transaction output (UTXO) based blockchain, the method being performed by a party using the blockchain, the method comprising: composing a transaction, wherein an output of the transaction comprises a locking script, wherein the locking script comprises a persisting smart contract that is arranged to persist through multiple transactions on the blockchain; wherein, as an unlocking condition, the locking script is arranged to require: the persisting smart contract to be present in a locking script of an output of a subsequent transaction; and/or a redemption condition of the persisting smart contract to be satisfied; wherein the persisting smart contract comprises a token identifier; and wherein the token identifier is associated with a contract transaction, which contract transaction is associated with the persisting smart contract, wherein the contract transaction defines the redemption condition; and outputting the transaction to the node.

Preferably, the transaction comprises (or is) the contract transaction.

Preferably, the transaction comprises (or is) an issuing transaction and/or wherein an input of the transaction references an output of the contract transaction, preferably an output of the contract transaction that is associated with the token identifier.

According to another aspect of the present disclosure, there is described a computer-implemented method of outputting a transmission to a node of an unspent transaction output (UTXO) based blockchain, the method being performed by a party using the blockchain, the method comprising: identifying an input of a transaction; identifying a locking script associated with an output of a previous transaction that is referenced by the input, wherein the locking script comprises a persisting smart contract that is arranged to persist through multiple transactions on the blockchain; determining a token identifier that forms a part of the persisting smart contract; determining a contract transaction that is associated with the persisting smart contract; comparing the token identifier to a variable of the contract transaction, preferably an address associated with the contract transaction; and outputting a transmission to the second party in dependence on the comparison.

According to another aspect of the present disclosure, there is described a computer-implemented method of configuring an unspent transaction output (UTXO) based blockchain so that in order to validate a transaction for inclusion in the blockchain a node is required to: identify an input of a transaction; identify a locking script associated with an output of a previous transaction that is referenced by the input, wherein the locking script comprises a persisting smart contract that is arranged to persist through multiple transactions on the blockchain; and output a transmission to the second node in dependence on: the persisting smart contract being present in a locking script of an output of the transaction; and/or a redemption condition of the persisting smart contract being satisfied; wherein the persisting smart contract comprises a token identifier; and wherein the token identifier is associated with a contract transaction, which contract transaction is associated with the persisting smart contract, wherein the contract transaction defines the redemption condition.

According to another aspect of the present disclosure, there is described a computer-implemented method of validating a transaction for inclusion in a block of an unspent transaction output (UTXO) based blockchain, the method being performed by a first node of the blockchain, the method comprising: identifying an input of a transaction; identifying a locking script associated with an output of a previous transaction that is referenced by the input, wherein the locking script comprises a persisting smart contract that is arranged to persist through multiple transactions on the blockchain; and validating the transaction in dependence on: the persisting smart contract being present in a locking script of an output of the transaction; and/or a redemption condition of the persisting smart contract being satisfied; wherein the persisting smart contract comprises a token identifier; and wherein the token identifier is associated with a contract transaction, which contract transaction is associated with the persisting smart contract, wherein the contract transaction defines the redemption condition.

According to another aspect of the present disclosure, there is described a an apparatus arranged to carry out the method of any preceding claim.

According to another aspect of the present disclosure, there is described a n unspent transaction output (UTXO) based blockchain comprising a block, wherein the block comprises a transaction, and wherein: an input of the transaction references an output of a previous transaction that comprises a locking script, wherein the locking script comprises a persisting smart contract that is arranged to persist through multiple transactions on the blockchain; wherein the locking script requires, as an unlocking condition, that: the persisting smart contract being present in a locking script of an output of the transaction; and/or a redemption condition of the persisting smart contract being satisfied; wherein the persisting smart contract comprises a token identifier; and wherein the token identifier is associated with a contract transaction, which contract transaction is associated with the persisting smart contract, wherein the contract transaction defines the redemption condition.

According to another aspect of the present disclosure, there is described an apparatus arranged to view, store, add to, validate, and/or access the aforesaid blockchain and/or a transaction and/or block of said blockchain.

Preferably, the apparatus comprises one or more of: a processor; a memory; a storage; a communication interface; and a user interface.

Preferably, the aforesaid apparatus comprises a node, a validating node, and/or a miner of the blockchain.

According to another aspect of the present disclosure, there is described a system comprising a plurality of the aforesaid apparatuses, preferably wherein the apparatuses are arranged to communicate with each other.

According to various aspects of the present invention, there is described:
A computer-implemented method of outputting a transmission to a second node of an unspent transaction output (UTXO) based blockchain, the method optionally being performed by a first node of the blockchain.
A computer-implemented method of configuring an unspent transaction output (UTXO) based blockchain, optionally so that in order to validate a transaction for inclusion in the blockchain a node is required to perform a method as aforesaid.
A computer-implemented method of validating a transaction for inclusion in a block of an unspent transaction output (UTXO) based blockchain, the method optionally being performed by a first node of the blockchain.
A computer-implemented method of outputting a transmission to a second node of an unspent transaction output (UTXO) based blockchain, the method optionally being performed by a first node of the blockchain.
A computer-implemented method of outputting a transaction to a node of an unspent transaction output (UTXO) based blockchain, the method optionally being performed by a party using the blockchain
An apparatus for storing an unspent transaction output (UTXO) based blockchain comprising a block, optionally wherein the block comprises a transaction.
An apparatus arranged to view, store, add to, validate, and/or access a blockchain.
A system comprising a plurality of apparatuses.

Each of these aspects may comprise any one or more of the aforementioned method steps and/or features. For example, where a computer-implemented method of outputting a transmission to a second node of an unspent transaction output (UTXO) based blockchain it will be appreciated that a similar computer-implemented method of validating a transaction for inclusion in a block of an unspent transaction output (UTXO) based blockchain is also disclosed.

Within this disclosure, the following terms and abbreviations are used:
Unsubstantiated tokens—tokens that are native to a blockchain (e.g. native Bitcoin tokens, aka satoshis), unsubstantiated tokens are typically not attached to (or representing) any real world (e.g. digital or physical) asset apart from the native (e.g. Bitcoin) tokens themselves.
Substantiated (transformed) tokens—tokens (e.g. tokens native to the blockchain, such as native Bitcoin tokens aka satoshis) that are attached to (or representing) specific real world (e.g. digital or physical) assets.
TX—a transaction.
UTXO—an Unspent Transaction (TX) Output: transaction output holding an amount of tokens and a locking script, where the UTXO must be unlocked in order to spend the tokens associated with this UTXO. The locking script of the output of the UTXO dictates conditions for the tokens of the output to be spent.
PKH—Public Key put through the SHA256 and RIPEMD160 hash functions aka “raw address”.
P2PKH—“Pay To Public Key Hash”: transaction output script (locking script) type considered for many years as “standard” for Bitcoin implementations.

With bitcoin implementations, the P2PKH script pattern typically contains a hashed public key (PKH) surrounded by ‘OP_DUP OP_HASH160’ and ‘OP_EQAULVERIFY OP_CHECKSIG’ opcodes (before and after it respectively).

In its raw hex script form is:“0x76a914”+PKH+“0x88ac”, and in raw (hex) transaction is preceded by Varint 0x19 due to its 25 bytes length.
Smart Contract—a UTXO is locked based on a locking script, which locking script comprises a smart contract. In the case of Bitcoin a UTXO may be locked based on a scriptPubkey. The locking script of UTXO being spent is executed during validation/evaluation of a transaction.

The execution occurs for each of a transaction's inputs independently, which inputs spend the output of previous transaction with that locking script (which locking script is being executed). Unlocking scripts, that may be referred to as scriptSig, placed in each of the inputs only pass parameters for those locking script executions.
OP_PUSH_TX—denotes an operational code that can be included in a locking script so that one of the conditions for unlocking that locking script may be the inclusion of all of the conditions (including itself) in the locking script/s of one, some or all of the next descendant transaction outputs.

Thus OP_PUSH_TX enables a smart-contract that enforces its own inclusion in a locking script/s of the output/s from one transaction to another by their spending events.

This creates a chain of transactions necessarily carrying the smart-contract in their output locking scripts, which termination is possible only when some specific conditions (encoded in the smart-contract too) are met (or satisfied).
In the scope of this document such a smart-contract is referred to as a forward-persisting smart contract (or in short an FPSC).
Assets—‘tokens representing assets’ are typically referred to as FPSC assets or just assets.
Maker—the initiator of an atomic swap, e.g. the party offering their assets in exchange for specific other requested assets, either publicly to anyone (unknown in advance) or directly to some known party.
Taker—the party that is taking the offered by maker assets and providing to him/her the requested assets instead.
Offered assets—the assets suggested by the maker (in exchange for requested assets) and received from the taker.
Requested assets—the assets requested by the maker and provided to him/her by the taker (in exchange for offered assets).

The invention extends to any novel aspects or features described and/or illustrated herein.

Further features of the disclosure are characterised by the other independent and dependent claims.

Any feature in one aspect of the disclosure may be applied to other aspects of the disclosure, in any appropriate combination. In particular, method aspects may be applied to apparatus aspects, and vice versa.

Furthermore, features implemented in hardware may be implemented in software, and vice versa. Any reference to software and hardware features herein should be construed accordingly.

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the disclosure can be implemented and/or supplied and/or used independently.

The disclosure also provides a computer program and a computer program product comprising software code adapted, when executed on a data processing apparatus, to perform any of the methods described herein, including any or all of their component steps.

The disclosure also provides a computer program and a computer program product comprising software code which, when executed on a data processing apparatus, comprises any of the apparatus features described herein.

The disclosure also provides a computer program and a computer program product having an operating system which supports a computer program for carrying out any of the methods described herein and/or for embodying any of the apparatus features described herein.

The disclosure also provides a computer readable medium having stored thereon the computer program as aforesaid.

The disclosure also provides a signal carrying the computer program as aforesaid, and a method of transmitting such a signal.

The disclosure extends to methods and/or apparatus substantially as herein described with reference to the accompanying drawings.

Embodiments of the disclosure are described below, by way of example only, with reference to the accompanying drawings.

### BRIEF DESCRIPTION OF THE DRAWINGS

FIG. 1 shows a blockchain.

FIG. 2 illustrates a computer device.

FIG. 3 shows a network comprising a plurality of nodes.

FIG. 4 shows a Bitcoin transaction.

FIG. 5 shows a forward-persisting smart contract.

FIG. 6 shows a forward-persisting smart contract for a substantiated token.

FIG. 7 shows an example of a contract data transaction.

FIG. 8 shows a flow of tokens after issuance.

FIG. 9 shows a token minimal structure.

FIG. 10 shows an example of an atomic swap.

FIG. 11 shows a transaction input data structure for an atomic swap.

FIG. 12 shows atomic swap methods for both unsubstantiated and substantiated tokens.

FIGS. 13-16 show methods of outputting transmissions based on the presence of a persisting smart contract.

FIG. 17 shows a method of performing an atomic swap.

### DETAILED DESCRIPTION OF THE EMBODIMENTS

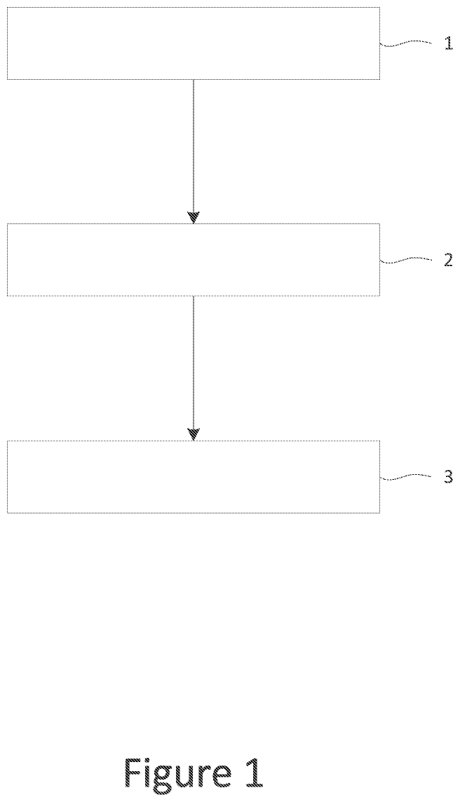

Referring to FIG. 1, there is shown a blockchain, which blockchain comprises a plurality of blocks 1, 2, 3. Each block is linked to a previous block; typically, each block comprises a hash of the previous block. A modification to the first block will alter the hash of the first block and therefore alter each of the following blocks. Since any modification to a block has an effect on each following block, any such modification can be immediately detected. Therefore, the blockchain can be used to provide an immutable ledger.

The disclosures herein are particularly applicable to a blockchain based on unspent transaction outputs (UTXOs). With a UTXO based blockchain, each block comprises one or more transaction that reference UTXOs. Typically, each transaction defines a transfer between at least one input UTXO and at least one output UTXO. Each UTXO can be used only once, so where a UTXO is used as the input to a transaction the entirety of the assets associated with that UTXO must be transferred to other UTXOs.

Since each UTXO is single use, it is difficult to implement smart contracts and other similar features on a UTXO based blockchain. This is because traditionally any data associated with each UTXO remains with that UTXO (it is not transferred to a new UTXO when the assets of the initial UTXO are transferred).

The present disclosures relate to methods of providing a smart script that is retained following a transaction that includes a first UTXO and a second UTXO, wherein a smart script that is associated with the first UTXO is (necessarily) also associated with the second UTXO.

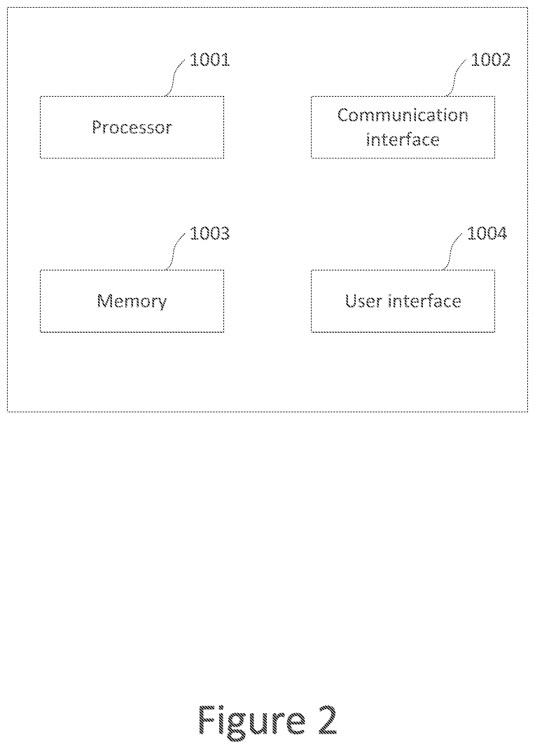

The systems and methods disclosed herein are typically implemented using computer devices, such as the computer device 1000 of FIG. 2.

The computer device 1000 comprises a processor 1001, a communication interface 1002, a memory 1003, storage 1004 and a user interface 1005.

The processor 1001 executes instructions, which may be stored in the memory 1003 and/or the storage 1004.

The communication interface 1002 enables the computer device to communicate with other computer devices. The communication interface may comprise a network adaptor, such as an ethernet adaptor. Equally, the communication interface may comprise a local area network interface, an infrared interface, a Bluetooth® interface etc.

The memory 1003 stores instructions that may be used by the processor 1001 as well as further data and/or information. For example, the memory may store a copy of the blockchain. The memory may comprise Random Access Memory (RAM), Read Only Memory (ROM), solid state memory, and/or flash memory.

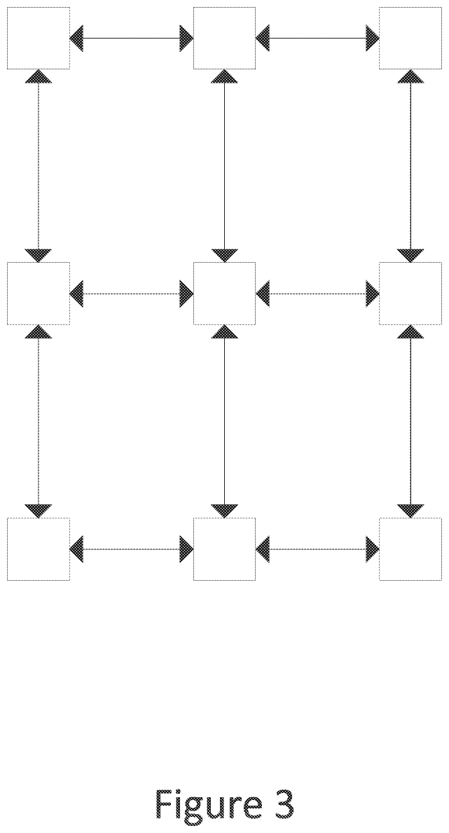

Referring to FIG. 3, there is described a network of nodes. The nodes of the blockchain are arranged to propagate the transactions and blocks of the blockchain throughout the network. Each of the nodes comprises a computer device, where the computer devices are arranged to communicate with each other to propagate the blocks of the blockchain.

Via this propagation, the computer devices are arranged to propose transactions and blocks for addition to the blockchain as well as to validate transactions and blocks. In order to add a block to the blockchain, a node is typically required to solve a cryptographic puzzle; for example, the node may need to determine a combination of a block hash and a nonce that gives a certain value when this combination is hashed. The remaining nodes may receive such a proposed block from a proposing node and may validate and/or propagate this block throughout the network.

The nodes of the blockchain include devices (and users) that: validate transactions and/or blocks of the blockchain; propose and/or add blocks of the blockchain (e.g. miners); and/or store a copy of the blockchain (either as a partial node or a full node). As used herein, nodes may include users that interact with (e.g. view) the blockchain, where these users may perform methods based on the information within the blockchain.

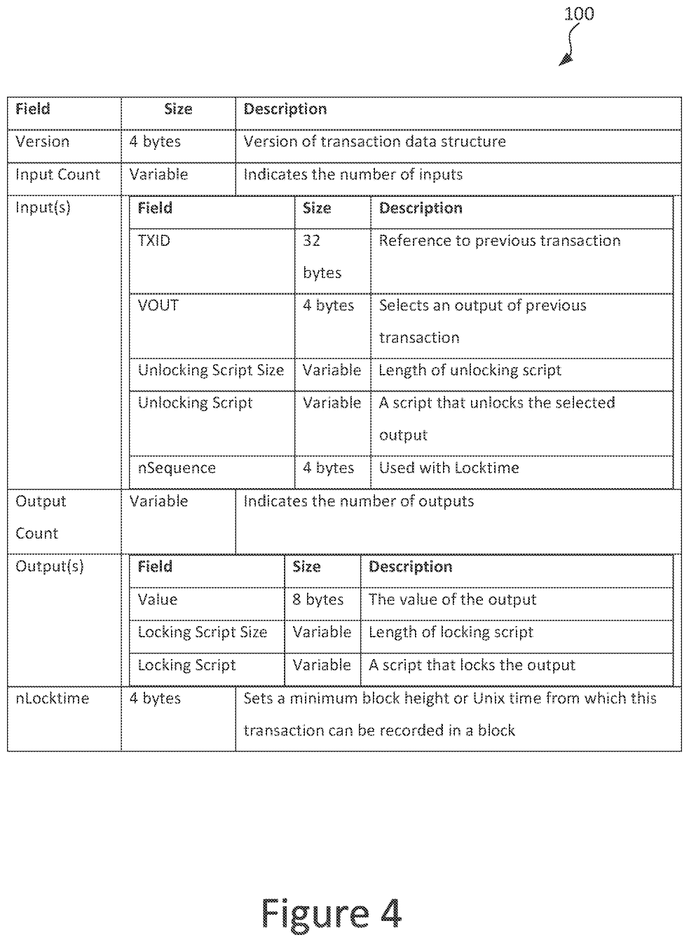

Bitcoin Transaction Structure: Referring to FIG. 4, a Bitcoin transaction is made up of a set of data fields. More specifically, in its raw form the transaction is made up of the serialised set of data fields which are typically represented in hexadecimal format.

A transaction has one or more inputs, where each input references an output of a previous transaction. Each input may reference a different output of the same previous transaction, or the inputs may reference outputs from different transactions.

Each output comprises a locking script, and each input includes an unlocking script (sometimes referred to as “ScriptSig”) that (if correct) satisfies the locking script of the referenced output and unlocks the referenced output.

An unlocked output of a previous transaction, or rather the amount of the digital asset previously locked to that output, can then be assigned to a newly created output/s by the current transaction.

The unlocked amount of the digital asset may be assigned in its entirety to a single output, or it may be distributed across more than one output of the current transaction.

nLockTime & nSequence:

The nSequence fields of every transaction input and the nLockTime field of the transaction collectively determine the “finality” of a transaction.

If a transaction is “non-final” then it cannot be valid but it can become “final” at a later time. If a transaction is “final” then it can be valid.

If the value of nSequence of a transaction input is 0xFFFFFFFF then that input is a “final input”.

If the value of nSequence of a transaction input is not 0xFFFFFFFF then that input is a “non-final input”—then the finality of the whole transaction is determined by nLockTime field.

If all of the inputs of a transaction are “final inputs” then the transaction is “final”, irrespective of the value of the nLockTime field.

If one or more of the inputs of a transaction are “non-final inputs” then:
If the value of the transactions nLockTime field is less than 500,000,000 then the field represents a block height.
   If the height of the block in which the transaction is being confirmed is greater or equal to the value of this field, then the transaction is “final”.
   Otherwise the transaction is “non-final”.
If the value of the transactions nLockTime field is greater or equal to 500,000,000 then the field represents a UNIX epoch timestamp.
   If the MTP of the last 11 blocks is greater or equal to the value of this field, then the transaction is “final”.
   Otherwise, the transaction is “non-final”.

A “final” transaction may be confirmed in a block following the “first-seen” rule.

A new transaction must replace a prior “non-final” transaction if it has the same inputs in the same order and every sequence number for every input in the new transaction is not less than the sequence number for the corresponding input in the prior transaction and the sequence number of at least one input in the new transaction is greater than the sequence number for the corresponding input in the prior transaction.

If a new transaction is detected which does not fulfil all of these requirements then it must be rejected.

If a new transaction is detected which has inputs that conflict with the inputs of a “non-final” transaction, but which are not identical to the inputs of the “non-final” transaction, then the “non-final” transaction is the “first seen” transaction and takes priority over the new transaction.

### Elliptic-Curve Cryptography and OP_PUSH_TX Method:

ECDSA signature formula:
Signature Generation
PubKey=PrivKey*GenPoint
(x1,y1)=RandNum*GenPoint
r=x1 (mod n)
s=(HashOfMsg+r*PrivKey)*RandNum⁻¹ (mod n)
The signature is (r, s)

In the case of Bitcoin (including its variations and derivatives), the HashOfMsg (hash of the message, called also sighash) parameter is a result of a double SHA256 of the serialization of the preimage, construction of which occurs in two variations, which can be defined as the legacy (or non-segwit) variation and the optimized (or segwit) variation.

The legacy variation works as follows (and as described in detail in https://en.bitcoin.it/wiki/OP_CHECKSIG):
1. the public key and the signature are popped from the stack, in that order. Signature format is [<DER signature><1 byte hash-type>]. Hashtype value is last byte of the sig.
2. A new subScript is created from the scriptCode (the scriptCode is the actually executed script—either the scriptPubKey for non-segwit, non-P2SH scripts, or the redeemscript in non-segwit P2SH scripts). The script from the immediately after the most recently parsed OP_CODESEPARATOR to the end of the script is the subScript. If there is no OP_CODESEPARATOR the entire script becomes the subScript
3. Any occurrences of sig are deleted from subScript, if present (it is not standard to have a signature in an input script of a transaction)
4. Any remaining OP_CODESEPARATORS are removed from subScript
5. The hashtype is removed from the last byte of the sig and stored
6. A copy is made of the current transaction (hereby referred to txCopy)
7. The scripts for all transaction inputs in txCopy are set to empty scripts (exactly 1 byte 0x00)
8. The script for the current transaction input in txCopy is set to subScript (lead in by its length as a var-integer encoded!)

The problem with this approach is that data hashing grows in O(n²) as the number of signature 30 checking in a transaction increases.

As a result of this, certain implementations of Bitcoin use the following optimized way (termed BIP 0143), which is described in more detail in https://en.bitcoin.it/wiki/BIP_0143 and https://github.com/bitcoin-sv/bitcoin-sv/blob/master/doc/abc/replay-protected-sighash.md#digest-algorithm).

The optimized preimage construction consists of the following current (the one attempting to spend) and previous (the one output of which is being attempted to be spent) transaction parts:
1. nVersion of the transaction (4-byte)
2. hashPrevouts (32-byte hash)−the double SHA256 of the serialization of the outpoints (transaction IDs and output indices) being spent by this transaction
3. hashSequence (32-byte hash)
4. outpoint (32-byte hash+4-byte)—ID and output index of transaction being spent by this input
5. scriptCode of the input (serialized)−previous transaction's output locking script, includes prefix carrying its length (called Varint)
6. value of the output spent by this input (8-byte little endian)−previous transaction's output amount of Bitcoin (in satoshi units)
7. nSequence of the input (4-byte)
8. hashOutputs (32-byte hash)−the double SHA256 of the serialization of all current transaction's outputs that is, amounts with their corresponding locking scripts
9. nLocktime of the transaction (4-byte)
10. sighash type of the signature (4-byte)

Apart from the optimization, there is one structural difference between these two sighash preimage variations, namely the legacy variation does not include the value/amount (6) of output that current input spends.

The inventions disclosed herein are applicable to both variations, albeit with a removal of some implementation steps for the legacy variation (these steps being related to the optimization) and with a single modification compensating value/amount not included explicitly in the preimage.

The description below first addresses the optimized version as it may be ported to the legacy one in a more trivial manner (than the other way around). The description then addresses the modification needed for the legacy case.

### Sighash Flags:

The Bitcoin operation code (op_code) CHECKSIG verifies signatures together with a non-script one-byte sighash flag/type argument, which indicates which part of the transaction the signature specifically endorses.

The input signature can endorse an entire transaction with a fixed set of inputs and outputs. The signature can also be selectively applied to specific outputs, so the transaction can include further outputs not endorsed by the signature.

| Sighash Type | Marker | Description |
|---|---|---|
| ALL | 0x01 | Signs all inputs and outputs |
| NONE | 0x02 | Signs all inputs, outputs modifiable |
| SINGLE | 0x03 | Signs all inputs and single output, |
| | | other outputs modifiable |

Selectively endorsing inputs is done with the ANYONECANPAY sighash modifier, which enables inputs to be modified after signing, and can be combined with the previous sighash markers.

| Sighash Type | Marker | Description |
|---|---|---|
| ALL + | 0x81 | Signs single inputs and all outputs, |
| ANYONECANPAY | | inputs modifiable |
| NONE + | 0x82 | Signs single input, inputs & outputs |
| ANYONECANPAY | | modifiable |
| SINGLE + | 0x83 | Signs single input, and single output, |
| ANYONECANPAY | | other inputs & outputs modifiable |

More detail on sighash flags can be found at https://wiki.bitcoinsv.io/index.php/SIGHASH_flags.

The following 3 fields of the sighash preimage are the ones linking inputs and outputs of the whole transaction in case of sighash flag ‘ALL’ (without ‘ANYONECANPAY’ one) being used when creating (signing) and validating the signature:
2. hashPrevouts
3. hashSequence
8. hashOutputs

These fields are unlike the others only hashes of parameters (and only in optimized sighash version).

### OP_PUSH_TX:

Each output of a transaction comprises a locking script. In order to enable a script relating to an output to persist through the blockchain, it is desirable for the locking script to require a subsequent unlocking script to provide information associated with the transaction containing this subsequent unlocking script.

Methods of forcing the unlocking script of an input of a transaction to provide information relating to this transaction are described in detail in WO2018/215871 and WO2018215873. Further relevant methods for referencing information in the transaction in an unlocking script of the transaction are described in applications: WO2019043538; WO2018215876; WO2018215947; WO2019034983; WO2018215875; WO2019034959; WO2018215872; and WO2021224428.

The combination of operational codes that achieve this goal are referred to herein as OP_PUSH_TX. OP_PUSH_TX requires:
ECDSA signing of the preimage corresponding to a current TX (pushed into its ‘unlocking script’) as part of script execution
calling OP_CHECKSIG opcode for verification of the signature

*this internal ECDSA signing is performed with arbitrary private/public key pair which are publicly seen/deduced since they are unrelated to those used for token possession relay.

**OP_CHECKSIG in this case functions as a validator, since when called it constructs its own preimage for ECDSA verification from actual current transaction fields (with 2 fields of previous one).

Hence if it will fail or succeed depends on the actual fields being identical (or not) to those pushed into unlocking script.
Signature Verification
w=s⁻¹ (mod n)
u1=HashofMsg*w (mod n)
u2=r*w (mod n)
(x2, y2)=u1*GenPoint+u2+PubKey
If r=x2 (mod n) signature is valid

This provides a forward-persisting smart contract, where the locking script of a transaction containing the persisting smart contract requires a subsequent unlocking script of an input of a subsequent transaction to show that the smart-contract has been replicated in an output of that subsequent transaction. Every forward-persisting smart contract is necessarily configured to generate a digital signature (e.g. an ECDSA signature) using the preimage from the unlocking script (passed to unlocking script as a parameter). The ECDSA parameters participating in this signing namely, the private key and ephemeral value k, with respective public key and r, all are part of (explicitly or as a results of math operations over them) and used by the locking script itself of the previous transaction, output of which is being spent. This locking script is the one being executed at the moment of spending.

After creating the signature over the preimage, the executed locking script verifies (by OP_CHECKSIG command call) that the digital signature is valid, against the public key corresponding to private key used for signing. During this verification another preimage is generated during OP_CHECKSIG call, but from the actual data fields of the spending transaction. For digital signature to be valid the two preimages must be an exact match.

OP_CHECKSIG command only succeeds (i.e. successfully executes) if the signature was made for the current spending transaction. Or in other words, only if the preimage passed as parameter to unlocking script was made from exactly the same actual transaction inside which the script is being executed.

As mentioned above, the all the ECDSA parameters are unrelated to those used for token possession relay, and therefore may be considered as a constants publicly seen/deducible without compromising the underlying asset itself.

An example of OP_PUSH_TX code is shown below, written in native Bitcoin scripting language for sig hash flag ‘ALL’:

OP_HASH256 OP_16 OP_SPLIT OP_15 OP_SPLIT OP_SWAP OP_14 OP_SPLIT OP_SWAP OP_ 13
OP_SPLIT OP_SWAP OP_12 OP_SPLIT OP_SWAP OP_11 OP_SPLIT OP_SWAP OP_10 OP_SPLIT
OP_SWAP OP_9 OP_SPLIT OP_SWAP OP_8 OP_SPLIT OP_SWAP OP_7 OP_SPLIT OP_SWAP
OP_6 OP_SPLIT OP_SWAP OP_5 OP_SPLIT OP_SWAP OP_4 OP_SPLIT OP_SWAP OP_3
OP_SPLIT OP_SWAP OP_2 OP_SPLIT OP_SWAP OP_1 OP_SPLIT OP_SWAP OP_CAT OP_CAT
OP_CAT OP_CAT OP_CAT OP_CAT OP_CAT OP_CAT OP_CAT OP_CAT OP_CAT OP_CAT
OP_CAT OP_CAT OP_CAT OP_SWAP OP_15 OP_SPLIT OP_SWAP OP_14 OP_SPLIT OP_SWAP
OP_13 OP_SPLIT OP_SWAP OP_12 OP_SPLIT OP_SWAP OP_11 OP_SPLIT OP_SWAP OP_10
OP_SPLIT OP_SWAP OP_9 OP_SPLIT OP_SWAP OP_8 OP_SPLIT OP_SWAP OP_7 OP_SPLIT
OP_SWAP OP_6 OP_SPLIT OP_SWAP OP_5 OP_SPLIT OP_SWAP OP_4 OP_SPLIT OP_SWAP
OP_3 OP_SPLIT OP_SWAP OP_2 OP_SPLIT OP_SWAP OP_1 OP_SPLIT OP_SWAP OP_CAT
OP_CAT OP_CAT OP_CAT OP_CAT OP_CAT OP_CAT OP_CAT OP_CAT OP_CAT OP_CAT
OP_CAT OP_CAT OP_CAT OP_CAT OP_CAT 00 OP_CAT OP_BIN2NUM OP_1ADD
414136d08c5ed2bf3ba048afe6dcaebafefffffffffffffffffffff00 OP_TUCK OP_MOD OP_2DUP
OP_SWAP OP_2 OP_DIV OP_GREATERTHAN OP_IF OP_SUB OP_ELSE OP_NIP OP_ENDIF
OP_SIZE OP_DUP 24 OP_ADD 30 OP_SWAP OP_CAT
022079be667ef9dcbbac55a06295ce870b07029bfcdb2dce28d959f2815b16f8179802 OP_CAT
OP_SWAP OP_CAT OP_SWAP OP_SIZE OP_DUP OP_IF OP_1SUB OP_ENDIF OP_SPLIT
OP_SWAP OP_SIZE OP_DUP OP_IF OP_1SUB OP_ENDIF OP_SPLIT OP_SWAP OP_SIZE
OP_DUP OP_IF OP_1SUB OP_ENDIF OP_SPLIT OP_SWAP OP_SIZE OP_DUP OP_IF OP_1SUB
OP_ENDIF OP_SPLIT OP_SWAP OP_SIZE OP_DUP OP_IF OP_1SUB OP_ENDIF OP_SPLIT
OP_SWAP OP_SIZE OP_DUP OP_IF OP_1SUB OP_ENDIF OP_SPLIT OP_SWAP OP_SIZE
OP_DUP OP_IF OP_1SUB OP_ENDIF OP_SPLIT OP_SWAP OP_SIZE OP_DUP OP_IF OP_1SUB
OP_ENDIF OP_SPLIT OP_SWAP OP_SIZE OP_DUP OP_IF OP_1SUB OP_ENDIF OP_SPLIT
OP_SWAP OP_SIZE OP_DUP OP_IF OP_1SUB OP_ENDIF OP_SPLIT OP_SWAP OP_SIZE
OP_DUP OP_IF OP_1SUB OP_ENDIF OP_SPLIT OP_SWAP OP_SIZE OP_DUP OP_IF OP_1SUB
OP_ENDIF OP_SPLIT OP_SWAP OP_SIZE OP_DUP OP_IF OP_1SUB OP_ENDIF OP_SPLIT
OP_SWAP OP_SIZE OP_DUP OP_IF OP_1SUB OP_ENDIF OP_SPLIT OP_SWAP OP_SIZE
OP_DUP OP_IF OP_1SUB OP_ENDIF OP_SPLIT OP_SWAP OP_SIZE OP_DUP OP_IF OP_1SUB
OP_ENDIF OP_SPLIT OP_SWAP OP_SIZE OP_DUP OP_IF OP_1SUB OP_ENDIF OP_SPLIT
OP_SWAP OP_SIZE OP_DUP OP_IF OP_1SUB OP_ENDIF OP_SPLIT OP_SWAP OP_SIZE
OP_DUP OP_IF OP_1SUB OP_ENDIF OP_SPLIT OP_SWAP OP_SIZE OP_DUP OP_IF OP_1SUB
OP_ENDIF OP_SPLIT OP_SWAP OP_SIZE OP_DUP OP_IF OP_1SUB OP_ENDIF OP_SPLIT
OP_SWAP OP_SIZE OP_DUP OP_IF OP_1SUB OP_ENDIF OP_SPLIT OP_SWAP OP_SIZE
OP_DUP OP_IF OP_1SUB OP_ENDIF OP_SPLIT OP_SWAP OP_SIZE OP_DUP OP_IF OP_1SUB
OP_ENDIF OP_SPLIT OP_SWAP OP_SIZE OP_DUP OP_IF OP_1SUB OP_ENDIF OP_SPLIT
OP_SWAP OP_SIZE OP_DUP OP_IF OP_1SUB OP_ENDIF OP_SPLIT OP_SWAP OP_SIZE
OP_DUP OP_IF OP_1SUB OP_ENDIF OP_SPLIT OP_SWAP OP_SIZE OP_DUP OP_IF OP_1SUB
OP_ENDIF OP_SPLIT OP_SWAP OP_SIZE OP_DUP OP_IF OP_1SUB OP_ENDIF OP_SPLIT
OP_SWAP OP_SIZE OP_DUP OP_IF OP_1SUB OP_ENDIF OP_SPLIT OP_SWAP OP_SIZE
OP_DUP OP_IF OP_1SUB OP_ENDIF OP_SPLIT OP_SWAP OP_CAT OP_CAT OP_CAT OP_CAT
OP_CAT OP_CAT OP_CAT OP_CAT OP_CAT OP_CAT OP_CAT OP_CAT OP_CAT OP_CAT
OP_CAT OP_CAT OP_CAT OP_CAT OP_CAT OP_CAT OP_CAT OP_CAT OP_CAT OP_CAT
OP_CAT OP_CAT OP_CAT OP_CAT OP_CAT OP_CAT OP_CAT OP_CAT 41 OP_CAT
038ff83d8cf12121491609c4939dc11c4aa35503508fe432dc5a5c1905608b9218
OP_CHECKSIGVERIFY

The size of OP_PUSH_TX in the above example is 512 bytes.

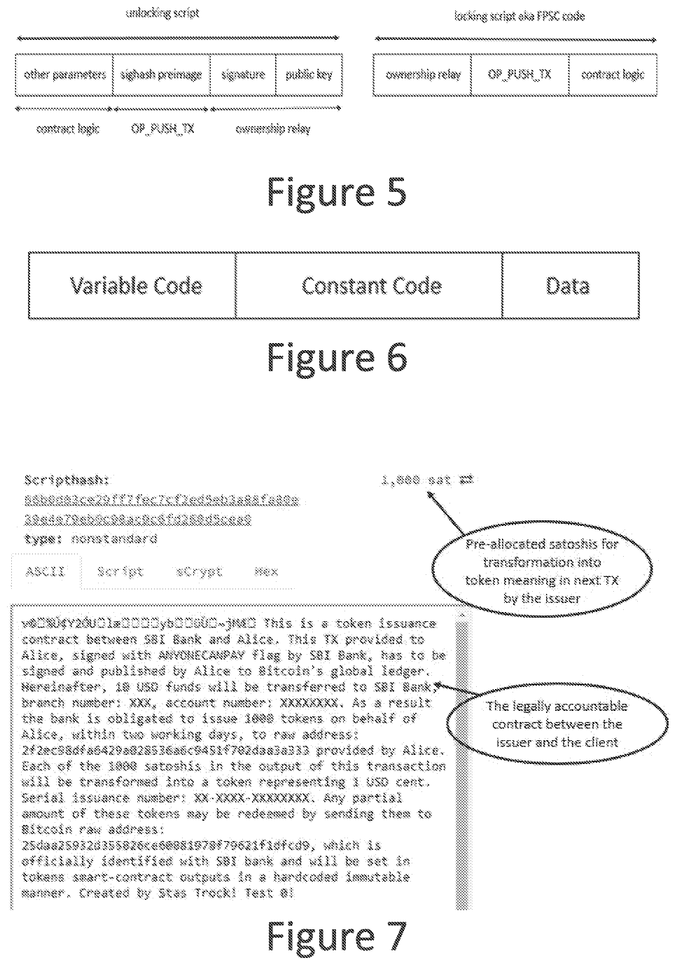

As shown in FIG. 5, the implementation of any forward-persisting smart contract roughly consist of three mandatory parts (an order of which is a matter of implementation):
1. Variable part for ownership relay, a standard transaction procedure.
2. ‘OP_PUSH_TX’ implementation—responsible for validation from within script execution of genuineness of the preimage (its fields identity to actual transaction fields) pushed into unlocking script of spending transaction.
3. The smart-contract logic itself, that includes constant code implementation and optionally variable fields needed for the contract logic.

FPSC are divided into two main categories (types), holding/carrying assets of:
1. native Bitcoin tokens, in their raw unsubstantiated form
2. substantiated Bitcoin tokens, representing real world assets

For a spending transaction to be successful, the forward-persisting smart-contract enforces:
1. Its own code immutability in an output's locking script from one transaction to another (from now and on called constant code part of the contract)
2. Rules by which variable part of newly created output's locking script may be changed (e.g. ownership relay to various addresses—standard transaction procedure. Or any other additional optional variable fields needed for the contract logic). From now and on this part is called variable data part of the contract.
3. Rules by which any of the spending transaction's fields, other than newly created output's ‘locking script’, may or may not be changed (optional part as well).

Referring to FIG. 6, there is described the structure of a forward-persisting smart contract for a substantiated token according to the present disclosure.

The substantiated token FPSC comprises three main parts:

1. Variable Code Part:

This part is intentionally at the very beginning of the script and is just a regular P2PKH sub-template (or more generally, a regular locking script), the reason for which is maximum possible compatibility for existing wallets and browsers, providing their searches by specific raw ECDSA addresses embedded in this fixed sub-template.

This is the part that designates the current holder and is used to pass on possession of the tokens through ECDSA usage.

2. Constant Code Part—The Token Mechanics Part:

This is the part of the FPSC that provides the forward persistence and the preservation of the substantiated state of tokens and includes the code part of the FPSC that ensures:
Token spending is possible only if the next newly created UTXO has exactly the same locking-script as the substantiated-tokens UTXO being spent has, apart from new possessor address update. Therefore, the constant part can neither be changed nor omitted through the time of the token's life.
A transaction that references an output comprising the FPSC creates (e.g. is required to create) new outputs that similarly include the constant code part, unless the new UTXO has a pre-determined hardcoded locking script (e.g. standard P2PKH) carrying a redemption address (also called protocol ID) that is identical to a redemption address one set in the token contract (locking script) upon its issuance (this token contract locking script will be described further below).
   Therefore, only the issuer of a token has an ability to turn a substantiated token representing an asset back into an unsubstantiated token thereby enabling this token to be used for its original regular use as a native token (e.g. by releasing underlying assets, e.g. USD, Gold etc.).
The amount of Satoshis each representing a token upon spending must be one of the following:
   unaltered—in case of plain transfer (either an envelope or a single-token type)
   split in two (or more)—in the case of a spending transaction having two (or more) outputs (e.g. partial spending with a change in second output) each of the outputs must have a locking scripts identical to the output being spent (sans the part carrying the possessor address).
   Straightforward plain spending (e.g. not merging, not swapping) may occur only from an execution in the context of a single chosen input (in the examples of this document it is chosen to be first (index 0)). Otherwise, spending an identical amount of substantiated tokens by each of a multiple inputs would succeed if the amount would be equal to the total amount carried by new outputs (the execution/validation would succeed per each such an input). This in turn would mean that tokens might be turned back into native satoshis (e.g. using change output) by a user, bypassing the hardcoded condition of redemption to a specific address only (e.g. to the issuer's address).

3. (Constant) Data Part:

The data part includes one or more of:
I. Token/s protocol global ID—e.g. specific fiat type pegged token or even various protocols per the same fiat type. It is this field by which the token types will be identified. For authenticity verification (second part of the protocol), this field must coincide with an address from which initial issuance transaction occurs.
II. Optional data field with a pointer (transaction identifier—TXID) to a special “contract” transaction (which is the previously mentioned as ‘contract publishing’ transaction).
III. Optional flags field, e.g.: designating if the token is splittable or not though its life cycle, designated by authorities as tainted.
IV. Optional data that token may carry, e.g. determining an NFT token, expiration or any other extra data.
V. Any other field required per specific case.

These fields are typically at the end and right after an OP_RETURN opcode that is a part of a locking script. The reason for this is that everything behind this OP_RETURN is not executed during script evaluation/validation and (as with the variable code part) a maximum compatibility for apps/browsers performing their searches on OP_RETURN transactions (unspendable data transactions), where OP_RETURN opcode is followed by protocol ID and then the rest of the data.

The protocol for generating (e.g. issuing) and then using a substantiated “Token” comprises (and/or consists of) three parts:
1. Placing a legal official contract between an issuer (the “substantiator”) and an issuee/s (the initial receiver of substantiated tokens upon their issuance) on the block-chain to serve as an immutable, transparent and undisputable evidence for a binding contract between these two parties. The contract is included as text in a special transaction called a ‘contract’ transaction. At this same transaction pre-allocation of native unsubstantiated Bitcoin tokens (satoshis) is taking place in order to transform these unsubstantiated Bitcoin tokens into substantiated ones which legally and technically start representing specific (e.g. digital or physical) assets.
   The pre-allocation happens into an output with a locking script carrying specific address, with which the issuer is legally associated and identified (necessary for both legal liability/accountability and authenticity verification).
   In order to be spent, this output requires knowledge of the private key corresponding to the public key with which issuer is associated/identified.
   The text of the contract embedded in the transaction relates to the transformation of these pre-allocated tokens, stating all the terms, conditions and obligations of the transformation/substantiation that will take place in the next transaction spending the current output (holding pre-allocated for substantiation satoshi/s), which will be called issuance transaction, “giving birth” to substantiated tokens held in its newly created outputs.
2. On the level of transaction's internal inherent script evaluation/validation - enforcing all the rules and logics on issued tokens, namely, preserving newly re-defined transformed (substantiated) state of the tokens and conditioning their reversal back to being native Bitcoin tokens.
3. On the level of transactions' global ledger—leaving for issued tokens immutable authenticity evidence for later tokens genuineness verification.

The purpose of this evidence is to prevent counterfeit tokens transactions, namely, to ensure the validity of token outputs they are trying to spend (the rest of token protocol is enforced on the script level).

In the way analogous to native Bitcoin tokens (satoshis) transaction verification—transaction's scripts may be valid (meaning when evaluated resulting in TRUE value), but still on the blockchain level the validity of the outputs the transaction is trying to spend must be checked too, namely the outputs must not only 1) be part of the blockchain but also 2) be unspent (in other words—must belong to current UTXO set).

### 1. Part One: Legal Official Contract—The Contract Transaction:

As already explained above, the contract transaction is the very first transaction preceding tokens issuance and it carries in it:
Initial issuance contract (e.g. between issuing entity and the client) with all its legal terms, conditions, license and any other possible necessary information related to this particular token/s attributes and its issuance.
   The initial issuance contract may be completely open to all, either fully or partially encrypted, whatever suits each specific case.
The exact satoshis balance predetermined to be transformed into tokens in a subsequent transaction (which will be the issuance transaction), which will have an output/s with smart substantiated token locking script/s (a substantiated token FPSC).

The contract transaction is a meeting point of human real world legal system and automata. There must be a point where these two meet, and there is no better time and place for this point to be than immutably on the blockchain and at the moment of token inception.

The text in the Contract transaction relates to satoshis being pre-allocated by that same transaction, stating obligations of issuing party actions to be performed on them once other party conditions/actions are met/done (stated there too).

Moreover it may hold metadata, used by infrastructures/wallets.

Script logic is not aware of the legal official contract and cannot reject or accept it.

The technical protocol starts from the issuance transaction, the spending contract transaction output with pre-allocated satoshis.

The contract transaction is a legal human agreement, that is recorded at the most appropriate time and space.

Instead of rewriting the whole contract text in each issuance by the same entity, subsequent transactions may just keep a pointer to the very first contract transaction (e.g. to consider it as a constitution).

Therefore, instead of each contract transaction having a constant part text and per-issuance variable one, it may instead contain a TXID pointer to the constitution, while the variable data if needed may have some per issuance specific data (for the constant data to not be reposted with each issuance).

For example, for a fiat-pegged Swiss Franc which may have a long legal contract, but at the same time be issued many times per day (as USDC today, issuing tokens for in return for fiat transfer to bank to specific account), this may spare a lot unnecessary text reposting.

The contract transaction output is a spendable data-output (or a spendable OP_RETURN output), since it carries data in the way regular OP_RETURN data-transactions outputs do, but with the difference that it has tokens in it and thus may be spent. Its simplest locking script structure may be: P2PKH, appended by OP_RETURN opcode, appended by legal contract text (e.g. in ASCII).

A pointer (TXID) to this transaction may (if desired) be an immutably set in data part of substantiated tokens FPSC for the rest of their life and every subgroup of tokens split from the initial group will forever carry the same pointer.

The contract data transaction is demonstrated with a self-explanatory example in FIG. 7:
In a first step, Alice requests a legal authorized entity to issue on her behalf a 1000 tokens (providing it with her address for reception).
In a second step, the entity creates an agreement (fills up the template) in the form of spendable data transaction with pre-allocated amount of satoshis in it (1000 satoshis) corresponding to the requested amount of tokens.
   The terms/conditions of the agreement state Alice's required actions (e.g. transfer corresponding amount of fiat money to the entity) and are signed by the entity part (with ALL|ANYONECANPAY flags, to allow Alice only to add her signature).
In a third step, Once Alice signs and publishes the agreement to the global ledger (blockchain) and performs the stated required actions, the entity issues the tokens on her behalf (with her address).
   Alice can now use/spend/transfer all at once or part of the tokens at her will, and the subsequent possessors may redeem the tokens at their will.

Various tokens would need various issuance complexity, some cases will include multiple legal documents others will be very simple or even completely automated.

The amount of pre-allocated tokens (in Satoshi units) held in these transactions outputs may be:
Single Satoshi—representing a single token (e.g. utility token: event, cinema, bus ticket etc.), meaning it's indivisible and can't be split during its life cycle.
Multiple Satoshis—representing an envelope with multiple tokens (e.g. USD-pegged tokens), from here and on called an envelope type.

### 2. Part Two: (I) Issuance. (II) Rules and Logics Enforcement on Already Issued Tokens:

The substantiation/transformation of native tokens happens in transaction called issuance.

This transaction is the one following contract transaction and spending its output holding in it pre-allocated for issuance native Bitcoin satothis as well as the legal contract describing, among other things, an obligation of the issuer to make this issuance transaction on behalf of specific initial receiver (issuee) once he/she in turn fulfilled his/her obligation stated in the same contract text.

The tokens are issued when they together with substantiated-token smart-locking-script constitute an output of such a described issuance transaction, which is maintaining from now and on their substantiated state through dictating specific conditions and restriction for their further spending.

The necessary most-basic actions required for proper issued token functioning are:
Contract publishing
Issuance (this is the first TX where the token comes to life and it spends the contract TX output)
Transfer
Split
Redemption

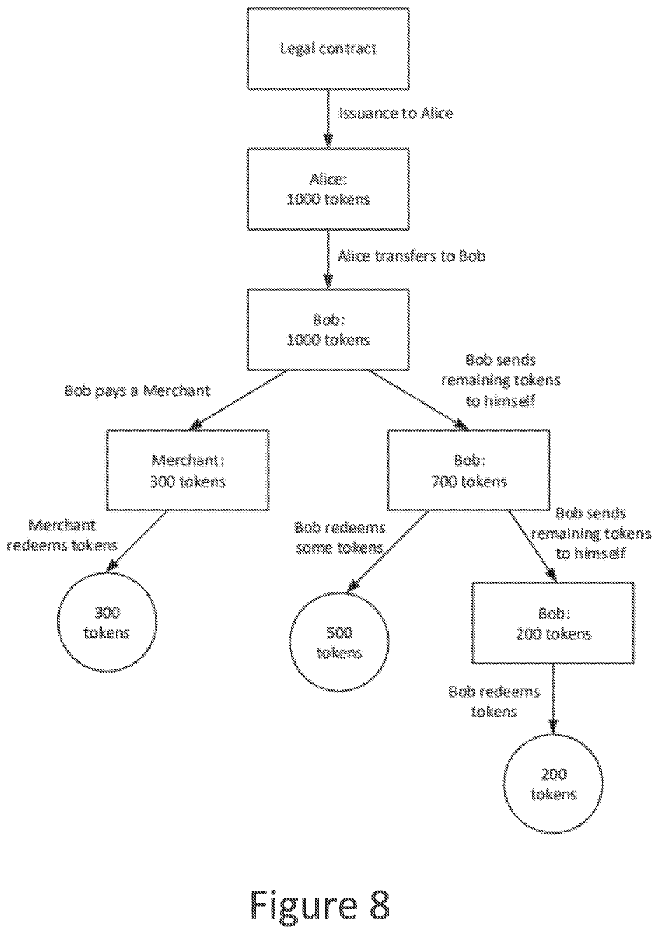

Simple (excluding merging, swapping etc.) tokens life flow after the issuance through these basic actions is demonstrated in FIG. 8.

What varies in outputs through these substantiated token transactions (with exception of redemption TX) is:
a. the possession address updated each hop
b. the amount of tokens that may be reduced through splitting (in case of envelope-type UTXO with multiple tokens).

Simply put, when a token is substantiated:
Each satoshi now represents a token and stops its regular functioning, regardless of the fact that it can represent something cheaper or more expensive than one satoshi itself.
It is impossible to move the tokens unless this exact constant code and data part of template is kept as a locking script in sending transaction output and unless, the amount of substantiated tokens in inputs is equal to the total amount of substantiated tokens in outputs. All that is possible to change is the possession address in the variable part (unless it is redemption, then the script is allowed to be changed to hardcoded pre-defined one, e.g. P2PKH).

Otherwise stated, this is not another “colour” coins implementation, which makes coins differ from the others only by carrying some meta-data attachments on them.

Rather the newly created tokens are a transformation of native Bitcoin tokens (satoshis) themselves, avoiding the decoupling of new tokens from their native associates which requires a burdensome and unnecessary coordination.

These tokens actually change their nature and mechanics with regard to ‘standard’ native Bitcoin tokens use.

It will be appreciated that the disclosures herein may also be used where the token continues to relate to the native token of the blockchain (e.g. where a token is associated with a FPSC but continues to represent an amount of Bitcoin). In such embodiments, the FPSC is still useable to limit the uses of such a token.

To facilitate explanation of both scripts and transaction types, below is a description an example of design of high-level rules enforced on the script level with splitting ability only in two and redemption locking script being P2PKH:
1. First output is used only for:
   i) redemption—standard P2PKH template, including mandatory hardcoded redemption address (PKH)
   ii) token relay—smart substantiated token locking script identical to format of the previous output spent by current TX.
2. Second output is optional (only for a case of splitting) and may constitute only of the smart substantiated token locking script type, in addition:
   If it exists: the token code requires the total sum of its and first output's amounts together to be equal to the amount in smart substantiated token UTXO being spent.
   otherwise: the token code requires the first output's amount to be equal to the amount in smart substantiated token UTXO being spent.
3. Last output is standard P2PKH template only (to arbitrary address)—if exists, used for a change of the payment (additional input) for tokens actions.

Any other number of outputs may be defined for splitting (2 is just a minimum), enforcing and behaving by exactly the same rules, as well as any other script template may be defined for redemption condition.

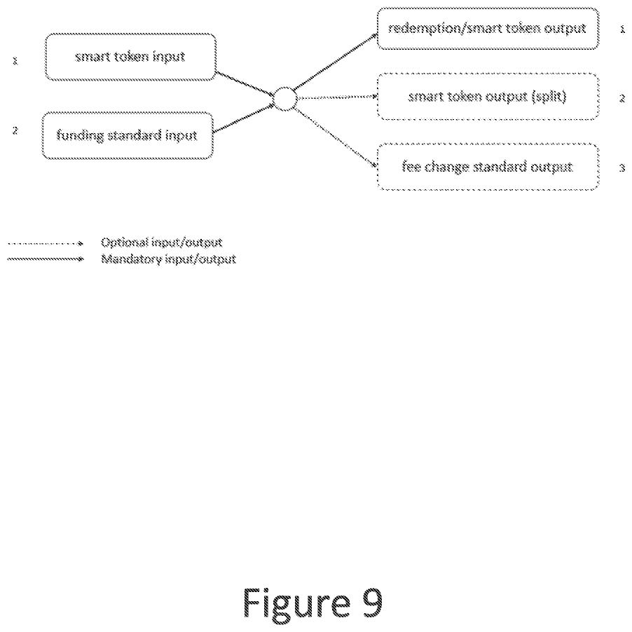

The example is depicted in FIG. 9.

The outputs in the figure:
may be either used for redemption (‘regular’ P2PKH output) or for transfer/split (smart output)
optional smart output—used in case of split only
optional ‘regular’ output—used either for TX fee payer's change or, in case of private atomic swap, token seller payment reception

Since the main idea is turning Bitcoin satoshis into tokens, we need access to previous and next amounts of transaction to control satoshis spending as well as previous and next locking scripts to control output locking script formats.

Once the sighash preimage, pushed into unlocking script, is validated to be identical to actual current spending transaction preimage, it is parsed for extraction of all relevant fields, which are:
2. hashPrevouts (32-byte hash)
5. scriptCode of the input
6. value of the output spent by this input (8-byte)
8. hashOutputs (32-byte hash)

While the locking script and value/amount of previous UTXO (that is being spent) are provided in preimage as they are, only hashes of all newly created outputs' locking scripts (combined with their new values/amounts) and previous outpoints (transaction ID with output indices) are available—hashOutputs and hashPrevouts respectively.

The new outputs locking scripts and amounts may be taken either from 1) the previous output being spent (as they are persisted to be identical, apart from the ownership relay part, necessarily carrying variable address field) and/or 2) must be provided along with their corresponding amounts next to sighash preimage in unlocking script. The output locking scripts along with their corresponding amounts must be concatenated and hashed to get validated against hashOutputs field of preimage (that has just been proved to be identical to the one that OP_PUSH_TX's OP_CHECKSIG constructed). The order of outputs concatenation is identical to the order of outputs in the transaction, thus is used to enforce described above rules on each specific output script and amount.

The outpoints of other than executed inputs must be provided as a parameter in unlocking script, to get concatenated with current input's self-outpoint (extracted from sighash preimage) and validated against hashPrevouts field (extracted from sighash preimage too). The order of outpoints concatenation is identical to the order of inputs in the transaction, thus is used to enforce current execution happening only in the context of the single specific chosen input (e.g. first input aka index

Once we have inside of the script code (being executed) all the necessary outpoints, locking scripts and amounts for transaction's previous and next outputs, it becomes feasible to enforce the token idea rules (demonstrated below in a self-explanatory code example with detailed comments).

In this forward-persisting smart-contract example, the smart contract persists itself into one mandatory output while the other optional outputs for splitting and TX fees change, may either exist or not.

As already stated, according to a demand, an implementation may support split into more than one mandatory and one optional number of outputs, carrying the same forward persisting smart token contract.

As well as having additional none, one or more outputs, carrying different non-FPSC locking scripts, e.g. change output from funding the transaction with standard P2PKH locking script in it.

The below self-explanatory code examples with detailed comments that elaborate the present disclosures.

The following is a substantiated token (locking) script code written in sCrypt language, high-level language which is JavaScript/Solidity derivative, adjusted for Bitcoin smart-contracts creation.

Splitting ability—up-to 2 substantiated token outputs, redemption script type—P2PKH, sighash preimage construction—optimized.

Of relevance to this code is that PUSH DATA opcodes are described at https://wiki.bitcoinsv.io/index.php/Pushdata_Opcodes. Varint is a format for indicating the size of upcoming data, as described at https://learnmeabitcoin.com/technical/varint.

```
contract Substantiated_Tokens {
        Ripemd160 redemption_PKH; // constant through token's life, set from outside (SDK)
        Ripemd160 owner_address; // set from outside (SDK) upon each relay
        // parameters passed to this function constitute the unlocking script itself (pushed to stack in left-
to-right order)
        // body of the spend( ) function consititutes locking script which gets executed over unlocking
script parameters
        // if second and/or third optional output doesn't exist,
        // OP_FALSE or zero values are passed to their corresponding address and amount pairs to
indicate it
        // equal to b″00″ in boolean comparison
        public function spend( bytes sighashPreimage,
                int amountOne, Ripemd160 PKH_One,
                        int amountTwo, Ripemd160 PKH_Two,
                              int amountChange, Ripemd160 PKH_Change,
        // this is a concatenation of TXID and output index of UTXO funding (with satoshis) the whole TX
                                                            bytes fundingOutpoint,
                                                                          Sig sig,
PubKey pubKey) {
        // ownership relay part (P2PKH sub-template):
        // to compare the raw addresses, cast public key through the SHA256 and RIPEMD160 hash
functions
                require(ripemd160(sha256(pubKey)) == this.owner_address);
                require(checkSig(sig, pubKey)); // then check the signature
                Tx tx = new Tx( );
                require(tx.validate(sighashPreimage)); // checks sighash preimage validity with sighash
flag 'ALL' (default)
                // read the prevHashouts
                bytes prevHashouts = sighashPreimage[4 : 36];
                // read outpoint that current input is spending
                bytes CurrentOutpoint = sighashPreimage[68 : 104];
        // validate current execution happens in the context of first input, which the order of concatenation
reflects
                require( (prevHashouts == hash256( CurrentOutpoint ++ fundingOutpoint ) ) );
                int len = length(sighashPreimage);
                bytes VarInt = sighashPreimage[104:107]; // includes 'fd' prefix and two bytes of size of
the script
                // read the length of the following VarInt script
                int lenScript = unpack(VarInt[1:] ++ b″00″);
                // read the whole smart substantiated token script (variable code, constant code and
data parts)
                bytes scriptCode = sighashPreimage[107 : 107+lenScript];
                // read the amount (called value) of tokens in the output being spent
                int value = unpack(sighashPreimage[len − 52 : len − 44] ++ b″00″);
                // read the hashOutputs - concatenation of all output locking scripts with their
corresponding amounts
                bytes hashOutputs = sighashPreimage[len − 40 : len − 8];
                // construct first output locking script:
                // it's either smart substantiated token script or standard P2PKH if the output is used for
redemption
                bytes FirstScript = b″00″;
      // is the address passed for first locking script equal to immutably set redemption address in the
script?
                if( PKH_One == this.redemption_PKH ){
                        // redemption may be part of split, but still must be first output
                        // Varint is 0x19 in case P2PKH, '0x76a9' is 'OP_DUP OP_HASH160',
                        // 0x14 is a byte of PUSHDATA size, PKH is the address of P2PKH, '88ac' is
'OP_EQUALVERIFY OP_CHECKSIG'
                        FirstScript = (b″1976a914″ ++ PKH_One ++ b″88ac″);
                }
                else {
                        // first first 23 bytes of smart substantiated token script are part of the P2PKH
sub-template, which is the variable part,
                        // '0x76a9' is 'OP_DUP OP_HASH160', 0x14 is PUSHDATA size byte, PKH is
the address of P2PKH
                        // after address the rest of the smart substantiated token script is immutable,
                        // thus may be used to validate immutability of smart substantiated token script
of the newly created outputs' locking scripts
                        FirstScript = (Varint ++ b″76a914″ ++ PKH_One ++ scriptCode[23 :]);
                }
                // concatenate amount(value) of the first output with the consturcted first output's locking
script
                bytes NextScripts = num2bin(amountOne, 8) ++ FirstScript;
                // second optional output for spliting tokens case (if exists, must be of identical smart
substantiated token script template, not P2PKH)
                if ( PKH_Two != b″00″){
                        // concatenate second output's smart substantiated token locking script and
amount to validate against hashOutputs at the end
                        NextScripts = NextScripts ++ num2bin(amountTwo, 8) ++ (Varint ++
b″76a914″ ++ PKH_Two ++ scriptCode[23 :]);
                        // validate the amount of tokens is preserved (they are locked, cannot escape
smart substantiated token script template),
                        // the spent output token amount must be eqaul to the sum of amounts of both
newly created outputs
                        require( value == (amountOne + amountTwo) );
                }
                else {
                        // if no split:
                        // only check that spent output token amount is eqaul to the amount in the only
newly created smart substantiated token output
                        require( value == amountOne );
                }
                // third optional output for possible change from transaction funding (if exists, must be
standard P2PKH)
                // concatenate it along with its amount of satoshis (as it's not smart substantiated token
script), to validate against hashOutputs
                if ( PKH_Change != b″00″){
                        // VarInt is 0x19 in case P2PKH, '0x76a9' is 'OP_DUP OP_HASH160',
                        // 0x14 is a byte of PUSHDATA size, PKH is the address of P2PKH, '88ac' is
'OP_EQUALVERIFY OP_CHECKSIG'
                        NextScripts = NextScripts ++ num2bin(amountChange, 8) ++ (b″1976a914″
++ PKH_Change ++ b″88ac″);
                }
                // validate that all addresses and amounts, that were passed to unlocking script as
parameters,
                // were equal to actual ones of this current transaction and were passed in the same
order transaction outputs are
                require( hashOutputs == sha256(sha256(NextScripts)) );
        }
}
```

For the case of legacy sighash preimage construction protocol (as used in Bitcoin variation ‘BTC’ at the filing date of this application):

As already mentioned above: apart from the optimization, there is one structural difference between legacy and optimized sighash preimage construction variations, namely the legacy variation does not include the value/amount of the output that a current input spends.

In order to implement the token substantiation method for the legacy sighash construction:
1. The function tx.validate (sighashPreimage) internals should be updated, as the fields inside the preimage appear in different order and as they are (without any hashing)—this is just an implementation change with little (or no) impact on the method.
2. The access to value/amount of the output being spent by current input, as well as enforcement of total amount preservation into the newly created outputs requires modification/re-implementation.

The value/amount of an output should be saved inside the substantiated token smart-contract/locking-script, similarly to address being a variable field of that contract, the value of each output should be encoded in the locking script itself and should be allowed to vary from one transaction to another.

Basically, an output carries its amount/value in two places:
1. Value field of the output
2. Additional variable value field inside the locking script of the same output

While the substantiated token script:
1. Enforces the content of these two value fields to be equal for all new substantiated token outputs (mandatory and optional) created with each new transaction. To achieve this it's sufficient to assign the same value to both fields (real output amount one and output amount within the locking script) when constructing hashOutputs preimage and validating it.
2. Accesses previous (being spent) output value/amount from corresponding output's locking script (by parsing it to read the previous value field), since the previous locking script is a part of the sighash preimage in legacy as in optimized preimage constructions.
3. Enforces the total amount of substantiated tokens preservation each transaction hop, by requiring the input (previous) amount to be equal to the total amount carried in the outputs (next)—no change needed.

Which becomes just a simple mathematical induction process performed by series of transactions.

Below are the two modifications (for 2 and 3) in code of substantiated token smart contract as described above. While the simplest straightforward place to hold the variable field carrying outputs value (amount) is defined to be the last 8 bytes of the script.
1) The lines 43-44 at the same script code should be substituted with:

// read the amount (called value) of tokens in the output being spent from last 8 bytes of the
previous locking script
// which necessarily contains previous output value (enforced by the script to be equal to
real value field)
int value = scriptCode[lenScript-8 :]

2) Modify construction of hashOutputs preimage at the addition of the first (mandatory) and second (optional, used for splitting) outputs.

The lines 61-63 at the same script code should be substituted with:

// after address the rest of the smart substantiated token script is immutable up to the last 8 bytes
carring output's value,
// thus may be used to validate immutability of smart substantiated token script of the newly created
outputs' locking scripts
// and at same time provide access to output's value/amount at next transaction, when the output
will be spent
FirstScript = (VarInt ++ b″76a914″ ++ PKH_One ++ scriptCode[23 : lenScript-8] ++
num2bin(amountOne, 8));

The lines 71-72 at the same script code should be substituted with:

// concatenate second output's smart substantiated token locking script and amount to validate
against hashOutputs at the end
NextScripts = NextScripts ++ num2bin(amountTwo, 8) ++ (VarInt ++ b″76a914″ ++ PKH_Two ++
scriptCode[23 : lenScript-8] ++ num2bin(amountOne, 8));

### Tokens Authenticity Verification

As substantiation of a token by its definition means connecting the tokens to a real world assets (in order the former to represent the latter), this connection must happen through identified trusted entity, which is trusted to issue the tokens in return for some real world actions e.g. assets deposition, and then trusted to provide a service (e.g. cinema entry ticket) or give the assets out (redemption) when specific contract conditions are met. Such an entity identification may be accomplished by its association with cryptographic keys, specifically used for the purpose of such an identification.

If an intermediary such as a bank, an airline company or the securities exchange are trusted to broker the value of the assets that Bitcoin token may represent. e.g. if they are trusted on the redemption of the assets they issued tokens for earlier, then they, instead of open market, may peg the value of native satoshis to specific real world assets.

The substantiating token smart contract (locking script) is what makes it possible. As it provides desired control over issued tokens on the script evaluation level. Namely, tokens can NOT be spent as native satoshis to a new output with any locking script in it (it is possible only if specific conditions set immutably in that contract met, e.g. redemption), instead the token script of unspent token output dictates (for the spending to take place) the form of the next output's script format to be of its own.

There is only one technical issue, which is a counterfeit. Legally issued tokens are secured and governed on the script level but, since the global ledger (block chain) is publicly open, anyone can see the token script template and create counterfeit tokens with the same output locking script (substantiated token smart contract), then maliciously use it as representatives of a real assets at his will.

And that's what the second part of the token protocol is providing through so called authenticity verification:

A first field of token data part (next after OP_RETURN opcode) is an asset/protocol ID, which is also an address that should be associated/identified with the real world issuer (or issuers, preferably using threshold signature technology, to avoid single point of failure). This address should be the 35 one which is included in the locking script of the output of the contract transaction containing pre-allocated for substantiation satoshis; the same output the very first token/s issuance transaction spends and by that turns the pre-allocated native tokens (satoshis) of the contract transaction output into substantiated ones. Spending of the contract transaction output demands knowledge of private key corresponding to the public-key/address with which the issuer is associated/identified. Therefore authenticity verification may be achieved by tracking trail of transactions outputs with substantiated tokens locking scripts back to this initial output of the contract transaction for the following reasons:
a) only genuine issuer could spend in order to transform/substantiate the tokens according to his/her legal obligation stated at this same output as text addendum (while simplest contract TX output locking script for this could be—P2PKH followed by OP_RETURN opcode, then followed by legal contract ASCII text).
b) once the token is issued its substantiated state preservation is guaranteed by its smart locking script wrapping the tokens in their outputs.

Thus the whole process constitutes simple mathematical induction.

Note, among token transaction inputs: first input (index—0) is always used for substantiated token spending, while others may be anything else (e.g. funding of the transaction).

Then, in order to validate token's authenticity, the path of its ancestor transactions on the global ledger (blockchain) should be checked (through input index—0), leading to the issuance transaction, performed by spending that same address (more precisely, spending contract transaction output with that same address, which has a format of—“P2PKH OP_RETURN <contract ASCII text>”) identical to token's immutable protocol/asset ID field.

Simply put, if there is an ancestor transaction (tracked through substantiated token scripts outputs) that was spent from address identical to the asset/protocol ID address, that is immutably encoded in the token data part, then the token is genuine, as only the possessor of the private key corresponding to identified with issuer address could perform this ancestor transaction which is the token's issuance transaction that ‘brought the token to life’.

Thus, the difference from regular native-satoshis-spending transaction, during transaction verification is that, the validity of outputs which are tried to be spent is determined not only by them being unspent (belonging to UTXO set) at the moment (like in case of native Bitcoin tokens), but also by being a descendants of a transaction which spent an output with standard locking script (preceding OP_RETURN and legal official contract text) with address, associated with a legal issuer and which is hardcoded into the token as protocol ID.

The token script (smart contact) described above is the method by which any issuer can transparently and openly convert generic unsubstantiated satoshis into a ‘minted’ token with a legal issuance contract.

In effect, the ‘issuance’ of a token, causes a satoshi to be ‘imprinted’ and transformed into a substantiated satoshi, which has restrictions on its use, and a real world asset assigned to it, transparently and immutably committed and backed by the issuer.

### Optimization:

Let us consider three different cases:
1. An issued token that doesn't need any app at all.
2. A token issued by business only for the use inside that business's app (and is meaningless outside of it).
3. A token issued for a global usage by various external apps which are unrelated to the issuer himself.

Let's assume that unlike the first case the last two are engaged in massive token usage and are interested in the performance to be highly optimized.
1. E.g. the token represents an asset, and is used only for asset redemption or occasional transfer between individuals (with no massive utility). In this case, trivial straightforward authenticity verification service may be performed by any entity naturally maintaining global ledger history.

For example, it may be:
a blockchain browser/archive (e.g. “whatsonchain.com”),
a non-pruning miner
a pruning miner which decides to provide this specific service and thus keeps TXs history related to specific tokens
any wallet that keeps its relevant TXs history anyway etc.

Moreover, it would be reasonable to expect in the future (if these tokens get adopted) appearing services specializing in keeping part of the blockchain engaged with tokens history only.

In other words, for this case the token should not be explicitly supported by any entities mentioned above, all they do for authenticity verification is reading the asset/protocol ID inside the token and browsing through ancestor TXs path to spot one whose spending address will be identical to the ID. This ancestor TXs browsing in reality is a low-cost operation, trivial enough to perform.
2. If a token is issued by business only for internal usage of its own app and the business is interested to optimize the process to avoid authenticity verifications for each of its token operations (which could be abundant).

The optimization may be achieved through just keeping (updating every block) the finite set of unspent outputs which are originated in business's own issuance transactions (with a corresponding spending address in the output, which is also the asset/protocol ID). Similarly to the way in which UTXO set is maintained and synchronized each block by miners, browsers, wallets etc. Only here the maintenance occurs for a specific UTXO subset (outputs originated from specific issuance transactions).
i. If such a business has its wallet built-in already, or the business itself is a wallet, or it is a miner (that accepts fees with fiat-pegged token of this protocol), in this case currently it keeps TX history and maintains UTXO set anyway. Therefore instead of maintaining a separate set of genuine token outputs for the optimization, it may just track a marked subset of the current UTXO set, which it keeps synchronized anyway. Thus the scanning ancestor TXs for verification may be substituted with a simple check of the token outputs attempted to be spent being in the marked UTXO subset, since counterfeit token transactions (spending illegal outputs) will end up in general UTXO set (outside of the marked subset). All the business does for authenticity verification is, marking specific subsets within the total UTXO set and updating it, while the result is O(1) complexity instead of O(n) (though the n itself is limited to the earliest issuance block/time of the specific substantiated token).

ii. As for a business not engaged with functionalities dealing with transactions/blockchain, there are tools, which allow one to have his own local synchronized TXO and UTXO indexer, only of the transactions relevant to it. Thus easily mimicking the same optimization technique while keeping only a set of genuine unspent token outputs.

Note that this is only an optimization, hence for any doubtful margin case, regular non-optimized straightforward authenticity check may always be the option.

It is important to understand that from a user perspective, both optimized and straightforward authenticity verifications are instant, thus for the apps/browsers/wallets which keep (next to UTXO set) the blockchain history or relevant part of it, the fuss of implementation of the optimization might not worth the efforts, given the straightforward TXs trail check is low-cost enough operation (and easy thing to implement/integrate).
iii. As for the case of a token issued for a global usage where issuer's only participation is redemption of the underlying asset at the end of token's life. An external (unrelated to the issuer) apps, businesses and individuals may find each either of the above authenticity verifications approaches matching their needs best. E.g. for officially issued USD tokens Walmart cashiers may need a highly optimized approach, while two individuals settling a private purchase deal between them may be satisfied with a direct verification.

### The Difference Between Substantiated and Native (Unsubstantiated) Tokens Implementations:

On the script level the token substantiating ‘smart’ script implementation is agnostic of token's attribution to real world assets.

All that matters is that the asset requires authenticity verification to bind the asset-representing tokens issuance to real world identity (of the issuer through his control of the cryptographic keys) or not.

For the unsubstantiated assets being just native Bitcoin satoshis, no authenticity verification is needed (for the reason of them being in their raw form and not representing any assets other than Bitcoin tokens themselves).

The above methods enable the transforming of native Bitcoin satoshis into tokens (one or multiple satoshi/s into one or multiple token/s), so that the tokens legally and technically start representing/constituting specific (digital or physical) assets.

In other words, the above-described methods of “Tokens Substantiation” are methods by which any issuer can transparently, and openly convert generic unsubstantiated native Bitcoin tokens (satoshis) and turn them into a ‘minted’ tokens with a legal issuance contract. In effect, the ‘issuance’ of a token, requires a Bitcoin satoshi token to be ‘imprinted’ and transformed into a substantiated tokens, which have specific conditions and restrictions on their use, and a real world asset/s (physical or digital) assigned to it (and/or backed) by the issuer.

The transformation is achieved with a help of smart locking script residing along with the tokens in transactions outputs, causing re-definition of native unsubstantiated Bitcoin tokens' nature and meaning, changing their mechanics.

Only under conditions hardcoded in token's integral smart-contract (transaction output locking script), the token may change its nature back to be used again as regular native (unsubstantiated)

Bitcoin tokens.

Token's forward-persisting smart-contract is residing in the TX output next to transformed/substantiated tokens, and is constitutes the output's locking script code itself.

It may as well be described as conditional burning: one burns the satoshis—meaning they are locked and can't be used in their natural way anymore, but if some specific conditions hardcoded in the token's smart locking script are met (e.g. conditions for redemption), then they can get back to being regular satoshis again, with no restriction in their usage.

All previous and current known attempts to create tokens on Bitcoin (starting from coloured coins years ago up to present time) defined tokens:
1) Either in additional data fields, in an unexecuted part of an output script code or even an additional separate unspendable output of the transaction (mostly using so-called OP_RETURN or ‘data’ transaction outputs), which are unrelated to native Bitcoin satoshi tokens and only using them as a carrier. The complex coordination between newly created tokens and Bitcoin native tokens (satoshis) always ended up in failed attempts to overcome this decoupling, eventually preventing from tokens reaching desired scaled mass adoption.
2) Or through colouring the native satoshis, which instead of working within the protocol's rigid confines, mostly used various hacks that modify functions of the original Bitcoin protocol such as, putting things that relate to token function in nSequence field of transaction.

And most importantly, the coloured coins can/could be spent by any regular wallet which is/was unaware of their colour, causing the loss of the metadata attached to the coloured coins (which the colour was designating).

In other words, coloured coins are completely dependent on the second layer software managing them. They are a ‘layer 2’ (over Bitcoin) solution by definition.

In contrast, the token substantiation methods described above use a smart locking script that locks satoshis' natural usage, making it impossible for wallets that are unaware of substantiation to accidentally spend them as regular satoshis. This has been the major flaw for all past colour coins creation attempts.

Any satoshi-based token solution without such a smart satoshis-locking script is essentially another variation of coloured coins.

The token substantiation techniques are possible due to the OP PUSH TX techniques that have been described above (and in previous patent applications), which allow transactions to be defined so that conditions are forwarded from one transaction to another.

Important to mention, even though substantiated tokens are a transformed native Bitcoin tokens, this does not mean that substantiated tokens are necessarily completely uncontrollable. If needed, they may be implemented with features that make them of various permissioned'types per demand (controlled to some degree by some specific third party during token's life time), e.g. confiscation by authority, spent by issuer after hardcoded expiration time etc.

As no so-called ‘layer 2’ additional software used for implementation of these kind of tokens, the tokens are as secure as Bitcoin itself.

In other words, the described substantiated tokens are not another “colour” coins implementation depending on second layer software management, which makes coins differ from the others either by carrying some meta-data attachments on them or by protocol hacks.

Rather the newly created tokens are a transformation of native Bitcoin tokens (satoshis) themselves, avoiding their decoupling from their native associates which requires a burdensome and unnecessary coordination.

These tokens actually transform their nature and mechanics with regard to ‘standard’ native Bitcoin tokens use.

As there is always a locking script next to the token/s inside a transaction output and the locking script is what defines the token's transformed/substantiated mechanics and nature, the term “substantiated token”as used herein implies the Bitcoin tokens adjacent in a transaction output are subject to such a forward-persisting smart-contract (locking script), which causes the tokens transformation/substantiation.

### Summary of Token Substantiation

Token substantiation is a process of transformation of the native tokens themselves into a new type of tokens, with a new meaning attached the substantiated tokens and new functioning in a way different from regular underlying native tokens.

The transformation is preceded by placing a legal official contract between an issuer and an initial receiver on global public ledger (block-chain) to serve as an immutable, transparent and undisputable evidence for a binding contract between these two parties.

The contract text is included in a special ‘contract’ transaction output which, among other things, contains pre-allocated native unsubstantiated Bitcoin tokens in order to substantiate them (in next TX), so they would start legally and technically represent/constitute a specific (digital or physical) assets.

The contract transaction output includes a locking script with a specific address with which issuer is associated/identified, and which is at the same time will be immutably hardcoded in the issued tokens' smart contract locking script to be used for both the authenticity verification and as an asset/protocol identifier.

The simplest contract TX output locking script for this could be—standard P2PKH template followed by OP_RETURN opcode, then followed by legal contract ASCII text.

Spending of the contract transaction output demands knowledge of private key corresponding to the public-key/address with which the issuer is associated/identified. Therefore, authenticity verification may be achieved by tracking a trail of transactions outputs with the substantiated tokens locking scripts (of the same format) back to this initial output of the contract transaction for the following reasons:
a) only genuine issuer could spend it, in order to transform/substantiate the tokens according to his/her legal obligation, which is stated at this same output as text addendum.
b) once the token is issued its substantiated state preservation is guaranteed by its smart locking script wrapping the tokens in their outputs, dictating/enforcing self-preservation of the script for further spending.

Thus the whole process constitutes simple mathematical induction.

The text of the contract states all the terms, conditions and obligations of the transformation/substantiation which will take place in the next transaction, which spends the current contract TX output (holding pre-allocated for substantiation satoshi/s); this ‘next’ transaction can be termed the issuance transaction.

This issuance transaction spends the output, holding in it pre-allocated for issuance native satoshis along with the legal contract text.

The tokens become issued when they together with substantiated-token smart-locking-script constitute an output of such an issuance transaction.

As described above, once issued, the substantiated state of the tokens is maintained by their smart locking script (adjacent to them in their UTXOs) through dictating specific conditions and restriction for their further spending, these new tokens no longer perform their regular function as the native tokens, unless converted back into the underlying digital asset under certain specified conditions encoded in themselves upon their issuance.

Thus, as already said, the transformation/substantiation is achieved through a specific locking script wrapping the native tokens.

In order for a token to be spent, assigned, or otherwise transferred, and therefore function as a substantiated token, a spending transaction to be successful must have in its next output (e.g. UTXO) the specific locking script contained in its previous transaction output, which is being spent. That is, like the token transaction output which is being spent, the spending transaction, in order to be able to be successfully transmitted, must include an output having a locking script that has the same constant component of the new token output. This constant part can neither be changed nor omitted through token's lifetime until its redemption.

In other words, this token's code part (among its various operations) in order to preserve token's substantiated nature dictates from one transaction to another: 1) its self-immutability, 2) impossibility of its own omission, and 3) (most importantly), preservation of tokens amount—that is, it locks the tokens, letting their amount (whole or a part) neither to be leaked as miners fees (would be the case if total outputs amount was less than total inputs') nor spent to any other than its own specific smart locking script format outputs (unless redeemed to a specified address and which is part of specified locking script, encoded in itself upon issuance). The preservation achieved through requirement/enforcement of total amount in smart inputs (carrying substantiated tokens) to be equal to total amount in smart outputs (carrying substantiated tokens).

Note, to avoid breach in such an amount preservation, for straightforward token spending (which is not e.g. merging or any type of swapping) smart token input must be enforced to be in a single specific input only (of specific input index).

In current document the single input enforcement was chosen to be on first input due to being a choice of simplest design and implementation, although in general straightforward substantiated token spending may be enforced to be any other than first input, as long it is single. This is a necessary part for token substantiation, as without it multiple inputs of the same amount which at the same time is equal to total output/s amount of substantiated tokens may be used to transform the tokens back to underlying asset of Bitcoin satoshi tokens, using funding change output (with unsubstantiated tokens) for it. Lack of this single input enforcement for regular straightforward spending actions may make the whole substantiation invalid.

Although, for non-straightforward spending actions the limitation should be expanded to number of inputs necessary for those actions, e.g. minimal merging needs two smart substantiated tokens inputs as well as minimal atomic swap between two various assets of substantiated token types.

The substantiation makes native tokens regular usage impossible while enforcing newly defined one, thus changing their mechanics and attaching to the tokens another meaning.

This has the effect that each single unit of the underlying digital asset (satoshi) now represents a redefined single token and stops its regular functioning. A single (or multiple) satoshi/s is/are now redefined as a single token. The owner of the token(s) cannot move the token(s) to another user unless the locking script contains exactly the same constant component, which enforces new token mechanics. All that can be changed in the locking script is the variable component which may be a standard sub-template (e.g. used in the same manner as in native tokens of underlying asset) responsible for transferring ownership, that is, enabling the current owner to move some or all of the token(s) to the next owner, according to an address included in such a standard sub-template.

The tokens of the present invention are the units of the underlying digital asset which have been reconfigured to function as distinct entities, operating by different rules (encoded in their smart wrapping/adjacent locking scripts).

As mentioned above, the tokens can be converted back into the underlying digital asset, i.e. to be used once again as the native token, if and only if the tokens are subject to satisfying particular conditions encoded in the above constant part of the script, e.g. a movement to predetermined redemption address. That is, only a hardcoded user or authority (i.e. the entity that has control over the redemption address, e.g. the initial issuer) has the ability to turn the tokens back into their initial regular nature of underlying digital asset, restoring their original functioning.

Note, for redemption and TX funding (miners' fees) change outputs, any other standard or non-standard locking script may be defined. We use here P2PKH (as example) only because it is most widespread locking script template used, in practice any other script may be defined/configured instead.

An issued substantiated token actions do not require any involvement of trusted third party or any computer server at all for an execution of the method between parties and may be accomplished through any direct communication, regardless of the way, means or protocol of that direct communication itself.

All the information necessary for authenticity verification (substantiated token transaction outputs trails back to their issuance transaction/s, where they were “born” and substantiated) resides on the public ledger (blockchain) and everyone may retrieve it in the way most suitable for him/her. An open source software for providing the authenticity verification may be written for local installation, such a software may listen to blockchain events and update each block marked UXTO subset corresponding to specific token/s relevant to user's interest. Simply put, this verification is just a fetching of relevant information from the blockchain (Bitcoin ledger), which requires no dependency on any third party.

Moreover, in future scalable world when Bitcoin will work with SPV, even the necessity for this authentication will become unnecessary at the moment of SPV transaction happening between peers, for the same reason SPV doesn't demand checking the outputs unspent state (being part of UTXO set).

The method may be used for any UTXO-based block-chain (of Bitcoin or on any of its forks/variations) that uses elliptic curve algorithms for signature construction and verification wherein a specific construct made from transaction fields/parts serves as an input being signed for the ECDSA formula. Such a construct (called sighash preimage) may be built by both the legacy and the optimized ways currently used in Bitcoin variations (forks). The slight modification needed for the legacy case is described above in the body this document.

Any forward-persisting smart contract roughly consists of three mandatory parts (variable part' for ownership relay, ‘OP_PUSH_TX’ and substantiated token contract own logic) described in FIG. 2. The invention is valid for any order of an appearance of these three parts (which is just a matter of implementation), the examples used in this paper are made of only one such a possible order.

Substantiated token script code structure imprints the token type by its constant code part, meaning a hash of this constant code part of the script may serve as an index for most general token type designation (e.g. for blockchain browsers/archives and/or wallets), which further is discriminated by data part field of asset/protocol ID designating asset's type.

Note, some substantiated token types may require the allowance of user independent (of an issuer) redemption (adding some mechanism to validate that user's action is not accidental, e.g. singing more than once and/or with specific ephemeral k values and/or specific sighash flags), other token types may require to allow even redemption by third party (e.g. authorities) instead or in addition to redemptions by-issuer and/or by-user with various conditions per each. In other words, redemption is limited neither to any particular script (as P2PKH in this document examples) nor to any particular type (e.g. to be by issuer only, as in this document), but rather may be encoded in the smart token script according to any demand.

Moreover, unlike in the examples of this document, for some substantiated token FPSC it may be reasonable to let for some of the fields of the data part token FPSC be variable, to allow them to change at any new output similarly to possession address of the variable code part. E.g. supply change tokens, holding most recent location information in their UTXO, while all the preceding history, held in previous outputs (which are already spent), may be extracted and read from on the blockchain.

The number of outputs into which substantiated tokens amount may be split is not limited to be two (as in this document examples), but rather may easily be expanded to any number at will.

Satoshi tokens ride on the back of Bitcoin tech, as they are Bitcoin themselves, only locked and bound to other than Bitcoin specific assets. They enjoy all the merits of Bitcoin itself—scalability, full

SPV and channels compatibility, existing indexing, optimization of authenticity verification—ability to avoid tracing back to issuance transactions through designating a relevant part of UTXO set and keeping track of it.

### Atomic Swaps

The tokens described herein can be used to implement atomic swaps in which two parties exchange assets effectively simultaneously (e.g. in a single transaction on the blockchain).

The method described herein achieve a peer to peer atomic swap and auction-ability requiring no involvement of trusted third party or any computer server for execution of the method between parties.

The atomic swap and auction-ability between two or more parties involved may be accomplished through any direct communication, regardless of the way, means or protocol of that direct communication itself.

The method achieves private and public atomic swaps in one transaction due to 1) a specific stepwise way of construction of such a transactions and 2) script code of FPSC, providing support for such an exchange/swap (in one or both participating parties, depending on specific assets being swapped).

Namely creating transaction parts in a specific order by each of the parties involved in an alternate manner, while at each step using a result of a previous step output (made by its counterparty) as an input for current partial (or complete) transaction being created.

The methods comprise, at each step, updating and manipulating with various transaction parts/fields, including ECDSA signing in a specific ways.

Importantly, transmission between parties of method's partial transactions which are the outputs of each step doesn't require any security mechanism. These partial transactions, carrying swappable FPSC in their outputs, cannot be used maliciously. As 1) they reveal no sensitive information of any of the participants and 2) only if the transaction construction reaches its final step the transaction execution/transmission becomes possible.

As the methods don't require locking the funds/assets of the smart contract being offered for exchange, the unspent transaction output (UTXO) carrying the funds may be offered at the same time for various other swaps of for different assets of various amounts, thus allowing racing on the asset exchange e.g. in auction-type manner. The ability to perform such a non-blocking funds/assets atomic peer-to-peer exchanges/swaps (in one transaction) is necessary to achieve peer to peer auction-ability.

The method may be used for public and private exchange of any number of FPSCs (with various amounts of corresponding assets) for any other number of different FPSCs (with various amounts of corresponding assets) in exchange for the suggested assets.

The methods may be used for private or public swapping in single transaction for any of forward-persisting smart-contracts assets of either substantiated or unsubstantiated types (from now and on called st-FPSC or ut-FPSC respectively).

For swapping of any FPSC (of either type) for a substantiated tokens FPSC (from now and on called st-FPSC) the method of transaction stepwise construction requires additional step with a simple modification, over swapping any FPSC for ut-FPSC type.

Both method variations will be described for swapping of any FPSC (of either type) for st-FPSC and for ut-FPSC.

These variations differ only in the way the transaction is constructed and are agnostic of the script code of FPSC that provides support for the swap

The script code of FPSC providing support for the swapping functionality typically must be present in at least one of the inputs to a swapping transaction and may or may not exist in the other, depending of the case.

On the script level there is no difference between st-FPSC and ut-FPSC atomic swaps, the FPSC implementation of swap support is agnostic of token's attribution to real world assets.

All that matter is rather the asset requires authenticity verification to bind the asset-representing tokens issuance to real world identity (of the issuer through his control of the cryptographic keys) or not.

For the unsubstantiated assets being just native Bitcoin satoshis, no authenticity verification is needed (for the reason them being in their raw form and not representing any assets).

Atomic swaps can be divided into two types:
1. Private aka direct—where the party suggesting the swap is aware of (e.g. knows the addresses of) the second party that is accepting the swap.
2. Public aka blind (tradability/exchangeability)—where the party suggesting the swap is unaware of (e.g. doesn't knows the addresses of) the second party that is accepting the swap.

Instead, blindly offering his asset for an exchange for another asset of his/her interest to anyone interested in it.

Public swap functionality includes functionality of the private swap, but not vice versa.

This disclosure describes a methods of a peer to peer (i) private/public atomic swaps and (ii) auction-ability; in (iii) one single block-chain transaction and; (iv) without locking the assets/funds (either of substantiated or raw tokens FPSC) of the smart contract being offered for exchange for the purpose of the swap.

For the scope of this document ‘tokens representing assets’ will be referred to as FPSC assets or just an assets.

The method of performing atomic swaps consists of two parts:
1. The identification of the FPSC, which supports the swaps on the level of its script template.
2. The stepwise construction of the transaction of the atomic swap.

### The FPSC:

On the level of script evaluation, the FPSC in order to successfully perform the swap, must support:
1. its persistence forward (keeping the exact same locking-script) to an output of an opposite index to the index of the input in which context it is being executed
2. the amount of tokens/assets in UTXO, being spent through current input, is preserved and kept unaltered in an output of opposite index to the index of the input in context of which execution happens

When the meaning of the opposite index of transaction inputs/outputs is as follows:
1. if the execution happens in the context of the first input of the transaction, then these conditions are enforced for the second output of the transaction.
2. if the execution happens in the context of the second input of the transaction, then these conditions are enforced for the first output of the transaction.

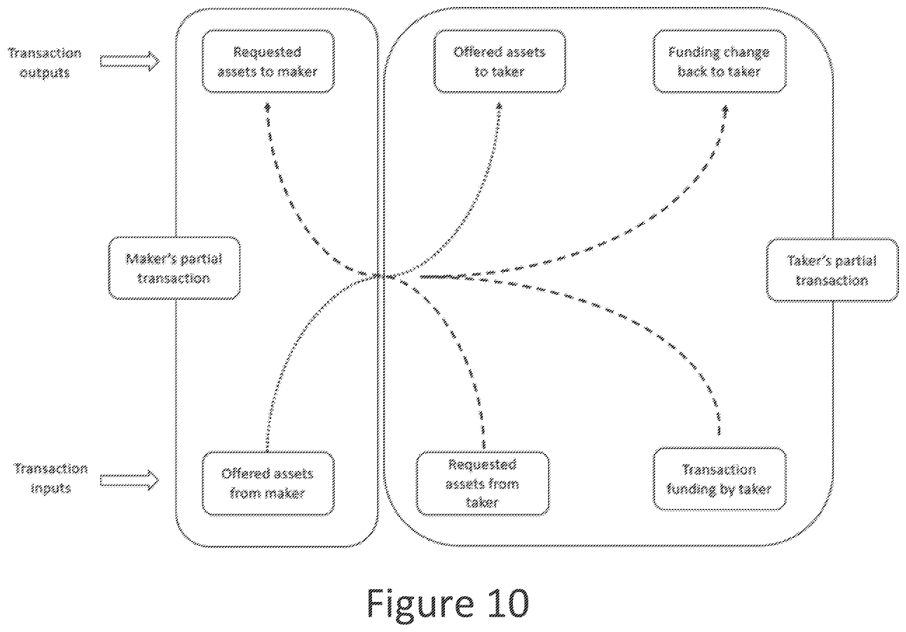

This is illustrated in FIG. 10.

It is important that the preservation of asset amount and the exact FPSC locking-script is enforced at each of the input context executions for both of the parties. Namely, each of the input context executions enforces itself and the counterparty input to the corresponding to each of them (e.g. the opposite) indices outputs. Otherwise, it would open a possibility for a various malicious exploits, e.g. by configuring one input for a swapping while the other as a regular FPSC transfer.

This method can be demonstrated through an addition of private/public swap support code to the self-explanatory example of the same “Token” FPSC code from above:

```
contract Substantiated_Swappable_Tokens {
        Ripemd160 redemption_PKH; // constant through token's life, set from outside (SDK)
        Ripemd160 owner_address; // set from outside (SDK) upon each relay
        // parameters passed to this function constitute the unlocking script itself (pushed to stack in left-
to-right order)
        // body of the spend( ) function consititutes locking script which gets executed over unlocking
script parameters
        // if any of second (used either for swap or split) and/or third optional outputs don't exist,
        // OP_FALSE or zero values are passed to their corresponding address and amount pairs to
indicate it
        // equal to b″00″ in boolean comparison
        public function spend( bytes sighashPreimage,
                int amountOne, Ripemd160 PKH_One,
                // if these 2 values are not OP_FALSE/b″00″ - second output is used for spliting (no
swap)
                        int amountTwo, Ripemd160 PKH_Two,
                              int amountChange, Ripemd160 PKH_Change,
                        // if these 2 values are not OP_FALSE/b″00″ - second output is used for swap (not
splitting)
                                            bytes counterpartyTX, int indexMate,
                        // this is a concatenation of TXID and output index of UTXO funding (with satoshis) the
whole TX
                                                  bytes fundingOutpoint,
                                                          Sig sig, PubKey pubKey) {
                        // ownership relay part (P2PKH sub-template):
                        // to compare the raw addresses, cast public key through the SHA256 and RIPEMD160
hash functions
                        require(ripemd160(sha256(pubKey)) == this.owner_address);
                        require(checkSig(sig, pubKey)); // then check the signature
                        Tx tx = new Tx( );
                        require(tx.validate(sighashPreimage)); // checks sighash preimage validity with sighash
flag 'ALL' (default)
                        int len = length(sighashPreimage);
                        bytes VarInt = sighashPreimage[104:107]; // includes 'fd' prefix and two bytes of size of
the script
                        // read the length of the following VarInt script
                        int lenScript = unpack(Varint[1:] ++ b″00″);
                        // read the whole smart substantiated token script (variable code, constant code and
data parts)
                        bytes scriptCode = sighashPreimage[107 : 107+lenScript];
                        // read the amount (called value) of tokens in the output being spent
                        int value = unpack(sighashPreimage[len − 52 : len − 44] ++ b″00″);
                        // read the hashOutputs - concatenation of all output locking scripts with their
corresponding amounts
                        bytes hashOutputs = sighashPreimage[len − 40 : len − 8];
                        // read the prevHashouts
                        bytes prevHashouts = sighashPreimage[4 : 36];
                        // read outpoint that current input is spending
                        bytes CurrentOutpoint = sighashPreimage[68 : 104];
                        int MateAmount = (-1);
                        bytes mateScriptCodeRemainder = b″00″;
                        bytes mate Varint = b″00″;
                        int inputContextIndex = (-1); // (-1) default value that designates a non-swap transaction
                        if ( counterpartyTX != b″00″ ) { // in swapping case, this parameter is demanded to be
non-FALSE
                              // extract FPSC locking script and amount, corresponding to output index
(indexMate)
                              // parse the transaction according to its structure,
                              // to skip all the part preceding the output of the given index
                              // according to definition these transactions may have either 2 inputs - FPSC
and funding,
                              // or 3 inputs - 2 FPSCs and funding, in case the transaction itself constituted
a swap too.
                              int numOfInputs = counterparty TX[4:5] // it's exactly 1 byte length (as its value
may be only 2 or 3)
                              if ( (numOfInputs != 3) && (numOfInputs != 2) ) {
                                      exit(false);
                              }
                              // Determine length of unlocking script (with its preceding VarInt) of the first
input
                              // version(4 bytes), num of inputs (1 byte), outpoint of first input (36 bytes) =
41 bytes
                              int FirstInputLength = length(
this.writeVarint(this.readVarint(counterparty TX[41 ]) ) );
                              // Determine the length of the unlocking script (with its preceding Varint) of the
second input
                              // 4 bytes for nSequence, 36 bytes for outpoint of the second input = 40 bytes
                              int SecondInputLength = length(
this.writeVarint(this.readVarint(counterpartyTX[(41 + FirstInputLength + 40) :])) );
                              int LengthToSkip = 41 + FirstInputLength + 40 + SecondInputLength;
                              int ThirdInputLength = 0;
                              if (numOfInputs == 3) {
                                      // Determine the length of the unlocking script (with its preceding
VarInt) of the third input
                                      // 4 bytes for nSequence, 36 bytes for outpoint of the second input =
40 bytes
                                      ThirdInputLength = length(
this.writeVarint(this.readVarint(counterpartyTX[(41 + SecondInputLength + 40) :])) );
                                      // 36 bytes for outpoint of the third input
                                      LengthToSkip = LengthToSkip + 36 + ThirdInputLength;
                              }
                              // 4 bytes for last nSequence and skip one byte (as its value may be only from
1 to 3) of num of outputs
                              LengthToSkip = LengthToSkip + 5;
                              int numOfOutputs = counterpartyTX[LengthToSkip-1 : LengthToSkip] // it's
exactly 1 byte length (value <= 3)
                              // according to definition FPSC output maybe either first or second
                              if ( ((indexMate != 0) && (indexMate != 1)) || (numOfOutputs <= indexMate) ) {
                                      exit(false);
                              }
                              if (indexMate == 1){ // skip first output (index 0), as the second is being spent
                                      Length ToSkip = Length ToSkip + 8; // skipt the amount(value) and the
locking script
                                      LengthToSkip = LengthToSkip + length(
this.writeVarint(this.readVarint(counterpartyTX[LengthToSkip :])) );
                              }
                              // save the amount to enforce its immutability in corresponding output
                              MateAmount = unpack(counterpartyTX[LengthToSkip : LengthToSkip + 8]);
                              // skip VarInt's Oxfd prefix
                              bytes mate Varint = counterpartyTX[LengthToSkip + 9 : LengthToSkip + 11];
                              // read the locking script of the output
                              bytes mateFPSCCode = this.readVarint(counterpartyTX[LengthToSkip + 8 :]);
                              // constant part behind address of variable part
                              // first first 23 bytes of FPSC are part of the P2PKH sub-template, which is the
variable part of FPSC,
                              // '0x76a9' is 'OP_DUP OP_HASH160', 0x14 is PUSHDATA size byte, PKH is
the address of P2PKH
                              mateScriptCodeRemainder = mateFPSCCode[23 :];
                              bytes MateOutpoint = hash256( counterpartyTX ) ++ num2bin( indexMate, 4
);
                              // it's unknown if the execution occurs in a context of input 0 or 1,
                              // hash of concatenation order that will be equal to prevHashouts, will
determine it
                              if ( prevHashouts == hash256( CurrentOutpoint ++ MateOutpoint ++
fundingOutpoint ) ){
                                      inputContextIndex = 0;
                              }
                              else if ( prevHashouts == hash256( MateOutpoint ++ CurrentOutpoint ++
fundingOutpoint ) ){
                                      inputContextIndex = 1;
                              }
                              else { // verification of passed outpoints of inputs failed
                                      exit(false);
                              }
                              // at this point, all the data of counterparty transaction (passed to unlocking
script)
                              // output of which is attemped to be spent, is authentic
                      } else {
                              // if it is not a swap: validate current execution happens NECESSARILY in the
context of first input
                              // the order of concatenation reflects current input index
                              require( (prevHashouts == hash256( CurrentOutpoint ++ fundingOutpoint ) ) );
                      }
                      // construct first output locking script:
                      // either FPSC (either own or in swap case - of the mate) or standard P2PKH if the
output is used for redemption
                      bytes NextScripts = b″00″;
                      if (inputContextindex == 0){
                              // if it's a swap and first input context - enforce mate's (second input) amount
and FPSC onto first output (index 0)
                              NextScripts = num2bin(MateAmount, 8) ++ (mateVarint ++ b″76a914″ ++
PKH_One ++ mateScriptCodeRemainder[23 :]);
                      } else {
                              // if it's non-swap and the address passed for first locking script equal to
redemption address set in the script?
                              if( PKH_One == this.redemption_PKH && (inputContextIndex == (−1)) ){
                                    // redemption may be part of split, but still must be first output
                                    // VarInt is 0x19 in case P2PKH, '0x76a9' is 'OP_DUP
OP_HASH160',
                                    // 0x14 is a byte of PUSHDATA size, PKH is the address of P2PKH,
'88ac' is 'OP_EQUALVERIFY OP_CHECKSIG'
                                    NextScripts = num2bin(amountOne, 8) + (b″1976a914″ ++
PKH_One ++ b″88ac″);
                              }
                              else { // either in the context of the second input during swap, or in first input
context without swap
                      // first 23 bytes of FPSC are part of the P2PKH sub-template, which is the variable part
of FPSC,
                      // '0x76a9' is 'OP_DUP OP_HASH160', 0x14 is PUSHDATA size byte, PKH is the
address of P2PKH
                      // after address the rest of the FPSC is immutable,
                      // thus may be used to validate immutability of FPSC of the newly created outputs'
locking scripts
                                    NextScripts = num2bin(amountOne, 8) ++ (VarInt ++ b″76a914″ ++
                                    PKH_One ++ scriptCode[23 :]);
                      }
                      }
                      if (inputContextIndex == 1){
                // is is a swap and second input context, thus enforce mate's FPSC (first input) onto second
output (index 1)
                              NextScripts = NextScripts ++ num2bin(MateAmount, 8) ++ (mateVarint ++
b″76a914″ ++ PKH_One ++ mateScriptCodeRemainder[23 :]);
                              require( value == amountOne );
                      } else {
                // if second optional output exists (for either spliting or swapping) it must be of identical own
FPSC template
                          if ( (PKH_Two != b″00″) | (inputContextIndex == (−1)) ){
                // concatenate second output's FPSC locking script and amount to validate against hashOutputs
at the end
                              NextScripts = NextScripts ++ num2bin(amountTwo, 8) ++ (VarInt ++
b″76a914″ ++ PKH_Two ++ scriptCode[23 :]);
                // validate the amount of tokens is preserved (they are locked, cannot escape FPSC script
template)
                              if ( PKH_Two != b″00″ ){
                // split: the spent output token amount must be eqaul to the sum of amounts of both newly created
outputs
                                        require( value == (amountOne + amountTwo) );
                              }
                              else { // swap: the spent output token amount must be eqaul to the
amount of the second newly created output
                                      require( value == amountTwo );
                              }
                      }
                      else {
// neither split, nor swap: the spent output token amount must be eqaul to the amount of the first newly
created output
                              require( value == amountOne );
                      }
                }
        // third optional output for possible change from transaction funding (if exists, must be standard
P2PKH)
        // concatenate it along with its amount of satoshis (as it's not FPSC), to validate against
hashOutputs
              if ( PKH_Change != b″00″){
                    // VarInt is 0x19 in case P2PKH, '0x76a9' is 'OP_DUP OP_HASH160',
                    // 0x14 is a byte of PUSHDATA size, PKH is the address of P2PKH, '88ac' is
'OP_EQUALVERIFY OP_CHECKSIG'
                          NextScripts = NextScripts ++ num2bin(amountChange, 8) ++ (b″1976a914″
++ PKH_Change ++ b″88ac″);
                  }
                  // validate that all addresses and amounts, that were passed to unlocking script as
parameters,
                  // were equal to actual ones of this current transaction
                  require( hashOutputs == hash256(NextScripts) );
        }
}
```

The swapping feature of the FPSC is agnostic of the type of FPSC 1) which it swaps as well as 2) to which it is swapped that is, it is identical for either st-FPSC or ut-FPSC types for both parties to/from which the assets are swapped.

The only difference in the method is in the transaction construction part and it is determined only by the type (st-FPSC or ut-FPSC) of the requested assets provided by the taker party.

The FPSC script itself is unaware of the order in which all the unlocking script parameters were supplied and the transaction was constructed, but its support is a mandatory as it enforces its persistence to the next outputs (of the opposite to its own current input's index).

FPSC script imprints the token type by its constant code part, which further is discriminated by protocol ID designating asset's type. The script swap support is not limited to swapping only assets of the same token type, but is capable to swap tokens of different structures (as long as they have a consensus over structure and location of the variable part inside FPSC).

### The Stepwise Construction of the Transaction:

In case of maker's offered assets being of st-FPSC type, their authenticity should be verified by the taker before his decision to proceed to performing his step of the transaction creation, therefore the taker is not at risk to receive counterfeit offered assets.

At the same time, the maker would risk his offered assets if the transaction creation would only require two steps (with the taker's step being last by definition) since the maker would have no way to check for authenticity of requested assets (if they were of st-FPSC type), therefore additional third step would be required in order to avoid third trusted party involvement.

Thus, we distinguish by the type of the requested assets two separate cases for the method, namely by being either st-FPSC or ut-FPSC. Specifically, for unsubstantiated requested assets the swap transaction may be completed in just two steps, while for substantiated ones it would require a three step handshake (with transaction transition at last third step).

The party making the last step is the one who transmits the whole complete transaction.

To completely avoid engagement of any third party the maker's initial asset offers may optionally be achieved through using blockchain, e.g. through OP_RETURN blockchain data storage method.

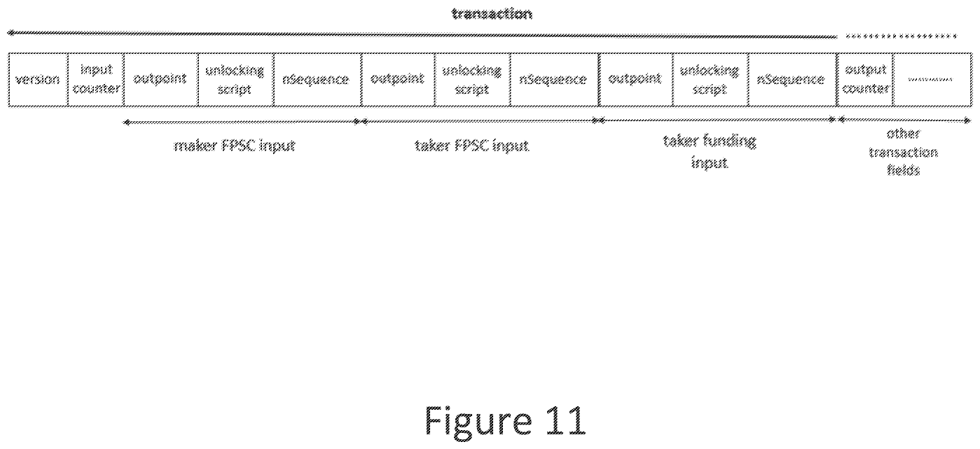

The final transmitted transaction inputs data structure is illustrated in FIG. 11.

As mentioned above, any FPSC locking script necessarily includes ‘ownership relay’ and OP_PUSH_TX parts in its smart contract (locking script) code, the function of unlocking script is to provide corresponding parameters for each of these parts. OP_PUSH_TX contract part involves ECDSA signing and verification, while ‘ownership relay’ only verification of provided signature (in unlocking script) as shown in FIG. 6.

More specifically, in order for a transaction that includes inputs spending outputs with such a FPSC locking scripts to be successfully executed/transmitted, for every such an input ECDSA signing and verification must inevitably happen at least twice.

For the ownership relay, the signature creation (input for which is transaction's sighash preimage) occurs off-chain during transaction construction, while signature's verification—during script evaluation execution by miner (transaction processor) as part of transaction validity check.

As for the OP_PUSH_TX part, both signature creation and verification occur during script evaluation as part of the transaction validity check. Namely, as the whole sighash preimage is pushed as parameter into unlocking script of particular input, the FPSC script constructs a signature (ECDSA signing) out of this preimage and calls OP_CHECKSIG command for verification of the signature and as by-product itserves as verification of the identity of pushed preimage's fields with actual transaction's fields.

In case of swappable FPSC (and in majority of other common cases), the OP_PUSH_TX verification must involve control over all of the outputs, which necessarily requires usage of sighash flag ‘ALL’ in it. And (as demonstrated above in the Token contract, supporting the swapping feature), it also necessarily involves control over all inputs thus adding ANYONECANPAY flag would prevent its proper functionality.

Therefore the only possible choice of the sighash flag being used in OP_PUSH_TX of swappable FPSCs must be the broadest one, which is singleton ‘ALL’. Important, this is not necessarily the case for the signing and verifying of the ownership relay part. Which may be performed with any sighash, flags if there are cases of stepwise transaction construction for which it is required.

Note, the unlocking scripts of transactions are not part of sighash preimage, meaning any kind of signing or verification does not involve any of the unlocking scripts of the transaction. This is a necessary element for a swapping ability of FPSCs. Namely, as signatures of asset owners and transaction sighash preimages both reside in unlocking script part of transaction inputs, in order to create signatures with ‘ALL’ flag and put them in the inputs spending assets of each party, it is enough for each of those parties to be aware of only four elements from the inputs and outputs of their counterparties—outpoint, nSequence, value (asset amount) and locking script (FPSC). For a simple reason that each of the 3 linking fields of preimage is a result of hashing of concatenation of one or two of these four elements with its corresponding elements from all other inputs or outputs of the transaction. The values of these 3 linking fields of preimage are the identical for preimage construction for any input of the transaction, if the preimage is constructed with ‘ALL’ flag.

As mentioned above, there are two sighash preimages to be constructed for each input spending FPSC assets: one 1) during creation of owner signature off-chain, another 2) explicitly put in the unlocking script as a parameter for OP_PUSH_TX input. It is mandatory for the latter be used with ‘ALL’ flag, but not for the former if the stepwise transaction construction needs and allows it. For example, if a party is not aware of other parts (inputs/outputs) of a transaction apart from his/her own input-output pair (which is what he/she wants to spend and wants to receive in exchange for it), the party may sign them with ‘SINGLE ANYONECANPAY’ flag, and leave the 3 linking fields in the preimage pushed into the unlocking script empty (which is possible as unlocking script is not participating in signing), so that these linking fields may be updated later by the counterparty, which at the moment is unknown; but if and when such a counterparty will emerge he/she will have full transaction data on hand (all transaction's inputs and all outputs data).

Simply put, the maker offering a public swap may sign what he offers (his single input) and requests in return for it (his single first output) with ‘SINGLE ANYONECANPAY’ flags, while if and when the taker will emerge, he in turn will:
1) sign for each of the rest of the transaction inputs with ‘ALL’ flag, apart from the first one (initiated by the maker), as he/she will be aware of all transaction's data/fields unlike the maker in the first step) and
2) complete the 3 missing linking fields in preimage pushed into unlocking script of maker's input to be exactly the same values as the preimage of his FPSC-spending input has (as OP_PUSH_TX of swappable FPSC is necessarily using ‘ALL’ flag, which makes its 3 linking elements identical for sighash preimages construction of both asset swapping inputs, similarly to Version and nLocktime fields)
3) complete all the necessary unlocking script parameters of maker's first input, which are either needed to be parsed and used for swapped forward-persistence enforcement (e.g. raw address to which taker receives offered assets in the second output) or simply part of concatenation for verification of others, which prior to their usage must be verified to be correct by comparison of the a hash of their concatenations to the 3 linking fields of preimage:
for prevHashouts calculation:
   full transaction and an output index constituting his (taker's) FPSC input outpoint
(must pass full transaction as after its verification it's parsed and used for swapped forward-persistence enforcement)
   funding transaction ID and an output index constituting funding input outpoint for hashOutputs calculation:
   amount and address of the FPSC variable part for his FPSC offered assets output
(it is enough to pass only an address, as the rest of the script is identical to the one in the output being spent and is completed from there)
   amount and address for funding standard P2PKH output
(it is enough to pass only an address, as the rest of P2PKH script is 5 known constant opcodes, hardcoded in the contract script)
hashSequence calculation may be provided as is, since swappable FPSC doesn't use nSequence field in its implementation
4) transmit the complete final transaction on a blockchain

This is the public FPSC swap method. It comprises two necessary steps:
1. the maker provides, or publishes publicly to anyone interested, a partial transaction including his/her first in a transaction input-output pair, with a signature (related to the ownership relay) in the input's unlocking script signed with ‘SINGLE ANYONECANPAY’ flags (covering only the first input and output of the transaction).
2. the taker (i) signs for each of the rest of the transaction inputs (both standard funding P2PKH and FPSC spending ones) with ‘ALL’ flag, and (ii) completes the 3 missing linking fields in the preimage pushed into unlocking script of maker's input with exactly the same values as in the preimage of his FPSC spending input, then (iii) completes the unlocking script parameters of maker's input either needed to be parsed and used for swapped forward-persistence enforcement or simply part of concatenation for verification of others, (iv) transmits the final complete transaction on a blockchain.

Since the maker has no ability to conduct authenticity verification of the requested assets provided to him/her by the taker, the above method is suitable primarily for the case where the requested FPSC assets are unsubstantiated raw Bitcoin tokens, meaning no authenticity verification is needed.

For the case where the requested assets are substantiated FPSC assets, the method requires three steps as follows:
1. the maker provides, or publishes publicly to anyone interested, the same partial transaction including his/her input-output pair, but without a signature (related to the ownership relay) in the input's unlocking script.
2. the taker does exactly all the same actions as he/she would do in the case with unsubstantiated requested assets above (maker's signature absence has no effect on taker's actions, since it doesn't participate in his signings, for the reason of being part of maker's unlocking script)
3. the maker (i) creates his/her signature (which was absent in the first step) with ‘ALL’ sighash flag (as now data for transaction's all inputs and outputs is available) and inserts it into his/her first input's unlocking script, and (ii) transmits the final complete transaction on a blockchain.

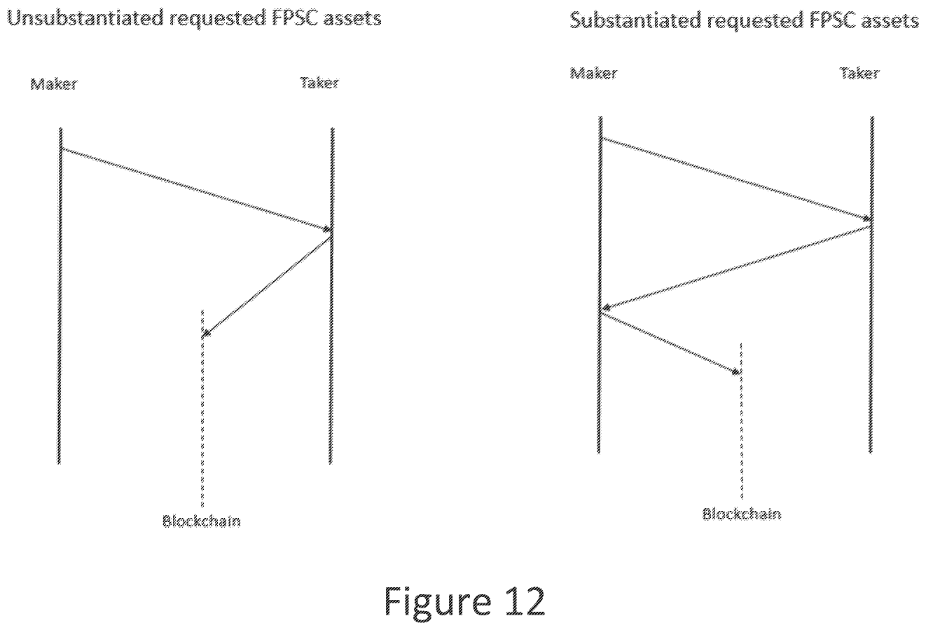

Both cases of swap methods for requested assets being of both types (ut-FPSC and st-FPSC) are demonstrated in FIG. 12.

The following below is an implementation of a transaction construction in the described above stepwise way for both private and public swaps for forward-persisting smart-contract with ut-FPSC type of requested assets (the minor difference for st-FPSC case is explained in the comments). Even though the below example is written in JavaScript, it may be perceived as pseudocode.
1. The maker publishes his offer in request for ut-FPSC assets (1st step):

```
let bitcoin = require('bitcoin')
var fs = require('fs');
var path = require('path');
let BN = bitcoin.crypto.BN // big numbers library
var buffer = require('buffer')
const flags = bsv.Script.Interpreter.SCRIPT_ENABLE_MAGNETIC_OPCODES |
bsv.Script. Interpreter.SCRIPT_ENABLE_MONOLITH_OPCODES
const sighash = bitcoin.crypto.Signature.SIGHASH_SINGLE |
bitcoin.crypto.Signature.SIGHASH_ANYONECANPAY
const slockStr = fs.readFileSync(path.join(path.resolve( ), 'Maker_offered_assets.json'), { encoding:
'utf8' })
const lockingScript_offered = bitcoin.Script.fromASM(slockStr)
const slockStr2 = fs.readFileSync(path.join(path.resolve( ), 'Maker_requested_assets.json'), {
encoding: 'utf8' })
const lockingScript_requested = bitcoin.Script.fromASM(slockStr2)
// amounts of tokens, either substantiated or not
const inputAmount0 = 117432
const outputAmount0 = 300
let utxo = {
  txId: 'fdea5212d13be1968362d161e7edfe6e9700a5d628413d4eac58526060f0db22', // some
imaginable TXID
    outputindex: 1,
    script: lockingScript_offered,
    satoshis: inputAmount0
}
let tx = new bitcoin.Transaction( ).from(utxo)
tx.addOutput(new bitcoin.TransactionOutput({
    script: lockingScript_requested,
    satoshis: outputAmount0
}))
// linking fields of the sighash preimage will be overwritten at step 2 by taker
const preimage_maker = bitcoin.Transaction.sighash.sighashPreimage(tx,
bitcoin.crypto.Signature.SIGHASH_ALL, 0,
                  lockingScript_offered,
                          new bitcoin.crypto.BN(inputAmount0), flags).toString('hex')
// imaginable private key
let privateKey_maker = new
bitcoin.PrivateKey('L3cnBSi5PhSkQWiF2VdQPMG1q4ekJ3LJDrxcGu87NmwT1p1fS7bU')
let publicKey_maker = privateKey_maker.publicKey
// maker signs with 'SINGLE | ANYONECANPAY' sighash flag
const sig_maker = bitcoin.Transaction.sighash.sign(tx, privateKey_maker, sighash, 0,
                  lockingScript_offered,
new bitcoin.crypto.BN(inputAmount0),
flags).toTxFormat( ).toString('hex')
// 'token_parameters_maker' is all the auxiliary unlocking script parameters known by maker at 1st
step.
// At the second step taker will complete all the missing parameters, that were unknown at 1st step
by maker.
const unlockScript_maker = bitcoin.Script.fromASM( token_parameters_maker + '' +
preimage_maker
                                                    + '' + sig_maker + '' +
publicKey_maker.toString('hex'))
// in case of requested assets being of substantiated tokens FPSC type - the unlocking script
assignment is done at 3rd step,
// after taker's update (at 2nd step) this maker's unlocking script with linking fields of preimage and
other missing parameters.
// The uncomplete 'unlockScript_maker' may be posted by maker next to serialized transaction.
tx.inputs[0].setScript( unlockScript_maker )
hex_tx = tx.serialize(true)
publish('Serialized transaction in hex: ${hex_tx}'});
```

2. The taker accepts the maker's offer, completes his part of transaction (that provides the requested ut-FPSC assets) and transmits it to the block-chain (2nd final step):

```
let bitcoin = require('bitcoin')
var fs = require('fs');
var path = require('path');
let BN = bitcoin.crypto.BN // big numbers library
var buffer = require('buffer')
const flags = bsv.Script.Interpreter.SCRIPT_ENABLE_MAGNETIC_OPCODES |
bsv.Script.Interpreter.SCRIPT_ENABLE_MONOLITH_OPCODES
const slockStr = fs.readFileSync(path.join(path.resolve( ), 'Taker_requested_assets.json'), {
encoding: 'utf8' })
const lockingScript_requested = bitcoin.Script.fromASM(slockStr)
const slockStr2 = fs.readFileSync(path.join(path.resolve( ), 'Taker_offered_assets.json'), { encoding:
'utf8' })
const lockingScript_offered = bitcoin.Script.fromASM(slockStr2)
// Taker's funding input script
const slockStrFunding = ″OP_DUP OP_HASH160 aa545fffaac444a8a40d9e111744e61b38625222
OP_EQUALVERIFY OP_CHECKSIG″
const lockingScript_Funding = bsv.Script.fromASM(slockStrFunding)
// amounts of tokens fitting to maker's offer (opposite order), either substantiated or not
const inputAmount1 = 300
const outputAmount1 = 117432
const inputAmount2 = 2000 // transaction funding (taker pays to miners), no change
let tx = tx.deserialize(fs.readFileSync(path.join(path.resolve( ), 'Maker_partial_TX.bin')))
let unlockScript_maker = tx.deserialize(fs.readFileSync(path.join(path.resolve(),
'Maker_partial_unlocking_script.bin')))
tx.addInput(new bsv.Transaction.Input({
  prevTxId: '355a5212d13be1968362d161e7edfe6e9700a5d628413d4eac58526060f0ff14', //
some imaginable TXID
  outputIndex: 0,
  script: new bsv.Script(lockingScript_requested),
}), lockingScript_requested, inputAmount1)
tx.addOutput(new bitcoin.Transaction.Output({
  script: lockingScript_offered,
  satoshis: outputAmount1
}))
tx.addInput(new bsv.Transaction.Input({
  prevTxId: '12389212d13be1968362d161e7edfe6e9700a5d628413d4eac58526060aaaff', // some
imaginable TXID
  outputIndex: 0,
  script: new bsv.Script(lockingScript_Funding),
}), lockingScript_Funding, inputAmount2)
// create unlocking script for second input (index 1)
const preimage_taker = bitcoin. Transaction.sighash.sighashPreimage(tx,
bitcoin.crypto.Signature.SIGHASH_ALL, 1,
                lockingScript_requested,
                        new bitcoin.crypto.BN(inputAmount1), flags).toString('hex')
// the following function extracts 3 linking fields from the given preimage (first passed parameter)
and
// copies them to the same fields of another sighash preimage extracted from unlocking script
(second passed parameter)
set_linking_fields(preimage_taker, unlockScript_maker)
// complete missing parameters of maker's input unlocking script. Note, no change output.
set_missing_parameters(unlockScript_maker, fs.readFileSync(path.join(path.resolve( ),
'Taker_outpoint_TX.bin')),
                indexTakerUTXO, fs.readFileSync(path.join(path.resolve( ),
'Funding_input_outpoint.bin')),
                                outputAmount1, PKH_taker)
// some imaginable private key
let privateKey_taker = new
bitcoin.PrivateKey('K3cnBSi5PhSkQWiF2VdQPMG1q4ekJ3LJDrxcGu87NmwT1p1fSaaa')
let publicKey_taker = privateKey_taker.publicKey
const sig_taker = bitcoin. Transaction.sighash.sign(tx, privateKey_taker,
bitcoin.crypto.Signature.SIGHASH_ALL, 1,
                lockingScript_requested,
                        new bitcoin.crypto.BN(inputAmount1),
flags).to TxFormat( ).toString('hex')
// 'token_parameters_taker' - amoung others, includes full outpoint transaction (and output index) of
maker's input
const unlockScript_taker = bitcoin.Script.fromASM( token_parameters_taker + '' + preimage_taker
+ '' +
                                                    sig_taker + '' +
publicKey_taker.toString('hex'))
// create unlocking script for the third, funding input (index 2), with some imaginable private key
let privateKey_funding = new
bitcoin.PrivateKey('L2cnBSi5PhSkQWiF2VdQPMG1q4ekJ3LJDrxcGu87NmwT1p1fSabb')
let publicKey_funding = privateKey_funding.publicKey
const sig_funding = bitcoin.Transaction.sighash.sign(tx, privateKey_funding,
bitcoin.crypto.Signature.SIGHASH_ALL, 2,
                lockingScript_Funding,
                      new bitcoin.crypto.BN(inputAmount2),
flags).toTxFormat( ).toString('hex')
const unlockScript_funding = bitcoin.Script.fromASM( sig_funding + '' +
publicKey_funding.toString('hex') )
// in case of requested assets being of substantiated FPSC type,
// instead of assigning unlocking script into input 0 in the next line of code,
// an updated 'unlockScript_maker' will be sent to maker along with the taker's partial transaction,
// for his final signature addition to it and trasmission of final transaction to the blockchain.
tx.inputs[0].setScript( unlockScript_maker )
tx.inputs[1].setScript( unlockScript_taker )
tx.inputs[2].setScript( unlockScript_funding )
hex_tx = tx.serialize(true)
// in case of requested assets being of substantiated FPSC type,
// instead of transmitting the final transaction to the blockchain, as in next line of code,
// the transaction will be sent back to the maker for his signature insertion in input 0 and
transmission to the blockchain
transmit_to_blockchain(hex_tx)
```

As mentioned above, the FPSC script itself is completely unaware of the order in which the transaction was constructed as well as the order in which the unlocking script parameters were supplied.

The swap method is not limited for exchanging only single FPSC output assets for another single FPSC output assets as was demonstrated in the token FPSC example.

Rather they may be extended to exchange of any number of offered FPSC assets (with various amounts) for any other number of different FPSC assets (with various amounts of each of the assets) in exchange for the offered ones.

For a multiple exchange at the first step the initiating party (the maker) must publish all the data corresponding of these multiple inputs (either with ‘SINGLE 1 ANYONECANPAY’ flags signature or for the case of requested assets of st-FPSC type, without a signature) and/or outputs. Then in exactly the same way it was done for a single assets-to-assets swap, the counterparty (the taker) is to complete the 3 missing linking fields in all preimages pushed into unlocking scripts of all maker's inputs with exactly the same values as in the preimages of his FPSC spending inputs, and insert the missing unlocking script parameters (that are needed to be parsed and used for swapped forward-persistence enforcements) in all maker's inputs.

Moreover, any partial data preceding the last final step cannot be used maliciously in any way and may be exchanged openly between the parties involved, without encryption and any trusted third party involvement.

Since, 1) the data reveal no sensible information of any of the participants and 2) only if the transaction construction reaches its final step the transaction execution/transmission becomes possible.

For example, the maker's offer may be done using blockchain, e.g. through OP_RETURN outputs data posting method. If the requested assets are of st-FPSC type, the same is true, for the second step made by the taker. All the coordination between these two may be managed fully by client-side-only app, listening to and querying blockchain events. However, it's in any way not an obligatory and any other coordination management is possible, as the invented method itself is agnostic of it.

In case of a private swapping, the taker may provide the maker with all the information needed in advance, therefore the swap may be achieved in two steps even if the requested assets are of a substantiated type, since maker is able to validate the authentic source of these taker's requested assets.

### Auction-Ability:

This feature becomes possible due to the ability to perform atomic swaps in a stepwise manner in one transaction without blocking the offered assets.
1. For the case when requested assets are of ut-FPSC type, the auction-ability is achieved using Bitcoin's native nLocktime and nSequence mechanism:
   This does not require the addition of any support to the forward-persisting smart-contract script code, which already supports the swap methods.
   Namely, the maker may post his partial transaction with offered assets, signed with ‘SINGLE|ANYONECANPAY’ flag, with the nLocktime field value set to particular time in the future.
   The transaction is not only partial, it's also non-final, meaning it allows the maker to post an offers of the same asset multiple times in return for another amount of requested assets or even other type of assets, as long as the nLocktime value set is greater than the current time (in other words, the offer's validity hasn't expired).
   Obviously, the nLocktime value may be represented in any of the two available formats either UNIX epoch timestamp or a block height, to be compared respectively to an MTP of the last 11 blocks or a height of the current block.
   Of course, in order for these partial transaction offers to be non-final the value of nSequence of their input (or inputs, for multiple assets offer), assigned by the maker, must be by definition less than 0xFFFFFFFF. And in order to supersede previous offers it must be increased for every succeeding post.
   Note that, since only if all of the inputs of a transaction are “final inputs” (with 0xFFFFFFFF value) the whole transaction becomes “final”, irrespective of the value of the nLocktime field.
   Therefore, even if the taker will assign the value of nSequence of his input to be 0xFFFFFFFF making it a “final input” (attempting to prevent further offers), the finality of the whole transaction still won't be affected as maker's input still carries a value less than 0xFFFFFFFF.
2. For the case when requested assets are of st-FPSC type, the auction-ability becomes trivial and obvious:
   The maker is the one setting assets offer at the first step of transaction construction and at the same time, is the one who controls the last (third) step of it (as without the addition of his last signature transaction successful transmission to the blockchain is not possible).
   When the maker's offer is taken (second step of transaction construction) meaning, there is a taker that signed for each of his/her own transaction inputs with ‘ALL’ flag, and completed all the missing parameters and preimage's the linking fields of unlocking script of maker's input, the maker may postpone last step of completion of the transaction construction and its transmission to the blockchain while instead publish new offer for the same assets output for the higher amount of requested st-FPSC type assets. If the new offer was taken too, its completion and transmission may be postponed as well for the sake of another new offer with even higher amount of st-FPSC type assets requested. And so on, until the process is terminated either due to the maker satisfaction or pre-determined time limitation.
   In other words, for requested assets being of st-FPSC type, the swapping method naturally automatically allows an auction-ability, even without a usage of Bitcoin's native nLocktime and nSequence mechanism.

### SUMMARY

The above disclosures have described a computer-implemented method of a peer to peer atomic exchange (swap) of entities (assets), managed with FPSC, between a first party and a second party (counterparty) (i) in a single transaction on a UTXO-based block-chain (such as Bitcoin or on any of its forks/variations) (ii) without blocking the assets being swapped during the process. As the method doesn't require locking the funds/assets of the smart contract being offered for exchange, the unspent transaction output (UTXO) carrying the funds/assets may be offered at the same time for various other swaps of different assets of various amounts, thus enabling a conduction of auction in a peer-to-peer manner between one party and multiple others.

The tokens managed by FPSC that are used in the swap/auction may be either in their raw form or representing assets other than Bitcoin, defined as their substantiation (carried by either ut-FPSC or st-FPSC respectively). At least one of the participants has to swap an FPSC assets (of any type). While the other one, may be either FPSC of any arbitrary type, e.g. a standard locking script.

The peer-to-peer swaps and auction-ability do not require any involvement of trusted third party for execution of the method between parties and may be accomplished through any direct communication, regardless of the way, means or protocol of that direct communication itself.

The peer-to-peer swaps and auction-ability are achieved due to both specific support from FPSC script and a specific stepwise way of transaction construction by two parties involved.

The specific swap support from FPSC enforces preservation of 1) assets amount and 2) exact FPSC locking scripts to the outputs of indices opposite to the indices of inputs in context of which execution happens. Namely, first input FPSC preservation is enforced to second output while second input FPSC to first output.

Important that this preservations of assets amount and exact FPSC locking-script will be enforced at each of the input context executions for both of the parties. Namely, each of the input context executions enforces itself and the counterparty input to the corresponding to each of them opposite indices outputs. Otherwise, it would open a possibility for a various malicious exploits, e.g. by configuring one input for a swapping while the other as a regular FPSC transfer.

During the stepwise transaction construction, the partial transactions being exchanged by parties, which are the outputs of each total transaction construction step, do not require a special securing mechanism. The partial transaction of swappable FPSC at any of the stages of its construction cannot be used maliciously and thus may be passed between parties openly/publicly. Since, 1) the data reveal no sensible information of any of the participants and 2) only if the transaction construction reaches its final step the transaction execution/transmission becomes possible.

The method may be used for any UTXO-based block-chain (of Bitcoin or on any of its forks/variations) that uses elliptic curve algorithms for signature construction and verification wherein a specific construct made from transaction essential fields/parts serves as an input being signed for the ECDSA formula. Such a construct (called sighash preimage) may be built by a legacy or optimized ways currently used in bitcoin variations, or any other future way.

As any forward-persisting smart contract (both st-FPSC and ut-FPSC) roughly consist of three mandatory parts (variable part' for ownership relay, ‘OP_PUSH_TX’ and contract own logic), the invention is valid for any order of their appearance (which is just a matter of implementation), the examples used in this paper are just one possible order.

The method is applicable to an exchange in one transaction of any number of offered FPSC held assets (with various amounts) for any other number of different FPSC held assets (with various amounts of corresponding assets) in exchange for the offered ones.

FPSC script code structure imprints the token type (determined by the hash of the constant code part of the FPSC) by its constant code part, which further is discriminated by protocol ID designating asset's type. The script swap support is not limited to swapping only assets of the same token type, but is capable to swap tokens of different structures (as long as they have a consensus over structure and location of the variable part inside FPSC).

The above description has primarily related to the application of methods to Bitcoin-based blockchains. It will be appreciated that more generally the methods and systems disclosed herein may be applied to any UTXO based blockchains.

There are described below methods that describe various aspects of the present disclosures; any of the features described above may be combined with these below methods (and vice versa). The majority of the preceding description has described an implementation based on a Bitcoin-based blockchain, and it will be appreciated that in practice the specific operation codes and the formats of transactions depend on the blockchain being used.

### Substantiated Token

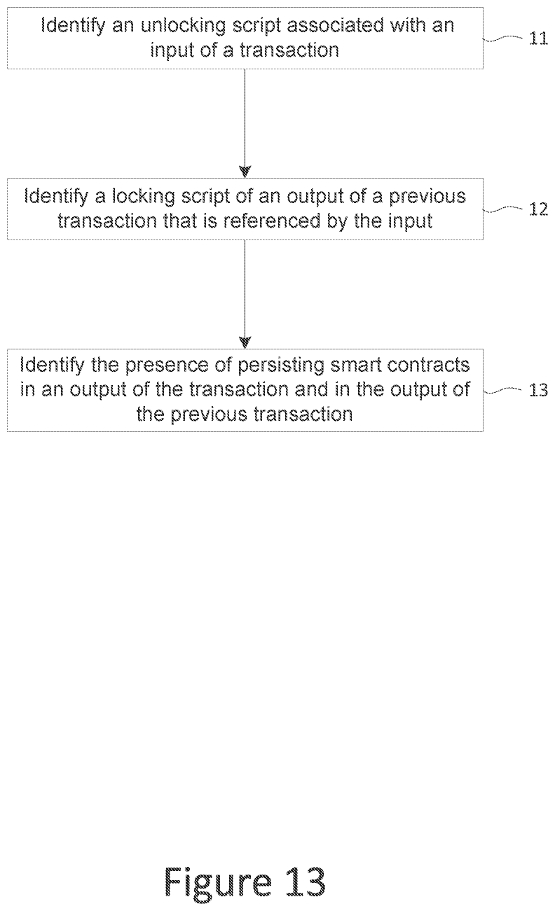

Referring to FIG. 13, there is described a method of outputting a transmission that is dependent on the presence of a persisting smart contract in a transaction. This method is typically performed by a node of the blockchain (e.g. a validating node), where the transmission may be related to the proposing or validating of a block, and/or may relate to the propagating of a transaction or a block through the network of nodes.

In a first step 11, the node identifies an unlocking script associated with an input of a transaction.

In a second step 12, the node identifies a locking script of an output of a previous transaction that is referenced by the input.

More generally, the node identifies an input of a transaction and determines the output of a previous transaction (a UTXO) that is referenced by the input transaction. The node is then able to determine whether an unlocking script of the transaction satisfies a locking script of a previous transaction. For example, the node is able to determine whether an unlocking script of the input demonstrates that a persisting smart contract from the locking script of the output of the previous transaction is replicated in the locking script of an output of the transaction.

In a third step 13, the node identifies the presence of persisting smart contracts in an output (a locking script of an output) of the transaction and in the output (a locking script of the output) of the previous transaction.

As described above, the locking script of the output of the previous transaction may comprise a persisting smart contract that is arranged to persist through multiple transactions. The locking script may require that a similar (or the same) persisting smart contract is also present in an output of the transaction and thereby is also present in an output of future transactions. In this context, the persisting smart contract may comprise the constant part of the FRSC described above so that the persisting smart contract may be replicated exactly in the output of the transaction. Equally, the persisting smart contract may comprise the further parts, such as an indication of ownership of the substantiated token and/or an indication of the value of the substantiated token. In this context, the persisting smart contracts in the output of the previous transaction and the output of the transaction may be similar, wherein the indication of ownership may differ between these persisting smart contracts. Indeed, the transaction may indicate a change in the ownership of the substantiated token, where this change in ownership is reflected in the persisting smart contract of the output of the transaction.

As described above, there is some risk of a party that is not the issuer of a persisting smart contract copying that persisting smart contract. Therefore, the persisting smart contract typically includes a hardcoded immutable token identifier that is associated with an issuing transaction. More specifically, the token identifier typically comprises a variable (e.g. a public key) associated with the issuing transaction. This variable may comprises one or more of: an identifier of an issuer of a substantiated token; a public key and/or public address associated with the issuer; and a public key and/or public address associated with the issuing transaction, preferably a public key and/or public address associated with a locking script of a UTXO that is spent by the issuing transaction.

In particular, the token identifier may comprise a public raw address (PKH) associated with (e.g.

referenced by an input of) the issuing transaction. This public address links the persisting smart contract to the issuer of the persisting smart contract, since only the issuer knows the corresponding private key (and so only the issuer would be able to validly sign the issuing transaction).

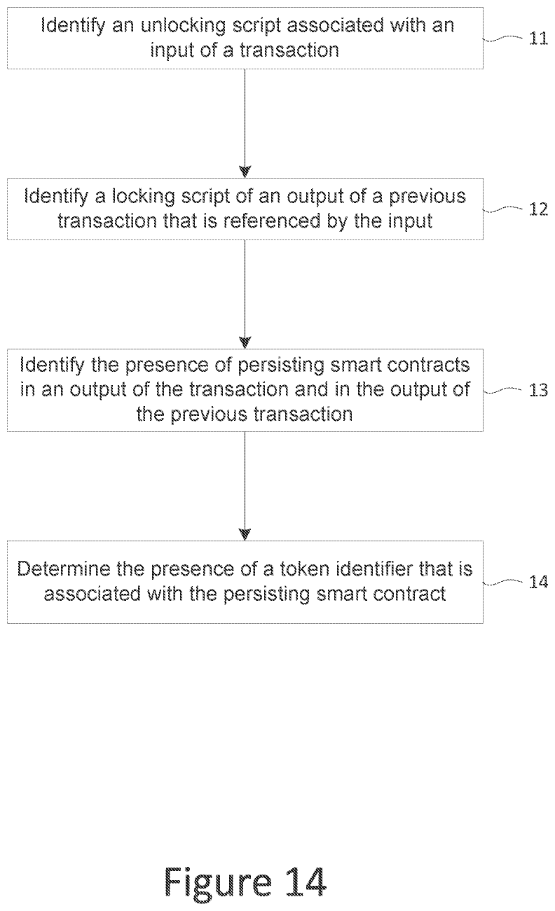

Therefore, referring to FIG. 14, the method may comprise a fourth step 14 in which the node determines the presence of a token identifier that is associated with the persisting smart contract.

This token identifier can then be compared to the value of the issuing transaction, and the transaction can then be validated or rejected by users in dependence on the token identifier being the same as (or being acceptably similar to) the variable.

In practice, the presence of the token identifier is typically determined by users of the blockchain (e.g. as opposed to validating nodes). These users may then determine whether to participate in a transaction based on a comparison between the token identifier and the issuing transaction. In such embodiments, the validating nodes may, or may not, undertake such a comparison.

The issuing transaction is associated with a previous (e.g. an immediately previous) contract transaction, where the contract transaction defines the terms of use of the substantiated token. The contract transaction is initiated by an issuer of the smart contract.

The contract transaction may define one or more of:
A redemption condition for the persisting smart contract.
   Typically, the redemption condition comprises a UTXO being sent to a specific redemption address, which address is defined by the contract transaction. Therefore, the issuer is able to include in the contract transaction a public address that is associated with the issuer. A locking script that comprises the persisting smart contract then has two alternate conditions that may be met to unlock an associated UTXO:
      1. The persisting smart contract is replicated in an output of a transaction that spends the UTXO (and in such a situation the tokens associated with the UTXO may typically be transferred to any address, optionally any address apart from a specified redemption address).
      2. The tokens associated with the UTXO are transferred to a redemption address defined in the contract transaction. In this case, the persisting smart contract is not present in subsequent locking scripts, so that these subsequent locking scripts may, for example, be standard P2PKH locking scripts.
   It will be appreciated that any redemption conditions may be used (e.g. a certain private key may need to be provided, or a certain cryptographic puzzle may need to be solved). In general, redemption conditions are defined by the contract transaction and thereafter, the unlocking of a locking script that comprises the persisting smart contract requires either the replication of the persisting smart contract or the satisfying of a redemption condition.
A use of a token associated with the locking script (e.g. the substantiated token). The contract transaction may define a value and/or representation of the substantiated token, where this value is typically associated with an asset (either physical or digital) that is external to the blockchain so that the substantiated token is no longer correlated with the blockchain.
Conditions, or restrictions, on the use of the substantiated token. The contract transaction may indicate that the substantiated token can only be used for certain purposes (e.g. that the substantiated token can only be transferred to a limited set of addresses and/or can only be transferred a limited number of times).
   Therefore, the method may involve the node (e.g. a validating node) determining a parameter of the transaction, where the transaction is accepted and/or rejected depending on this parameter and on the conditions defined in the contract transaction. For example, the node may determine a recipient of the transaction and reject the transaction if this recipient is not in a list of acceptable nodes that is included in the contract transaction.
An issuance contract. This issuance contract text is typically included in the contract transaction as data in ASCII format, where it may be placed after an operation code that causes a transaction output locking script execution termination (e.g. an OP_RETURN operation code).

The contract transaction may relate to any number of tokens. Where the contract transaction relates to a plurality of tokens, these tokens may be split in subsequent transactions as has been described above.

In order to preserve the amounts of tokens associated with the specific substantiation, the locking script typically requires the outputs of any transaction that includes the locking script to have the same value (amount) of these substantiated tokens to be spent through the inputs of that transaction. Equally, the outputs of a transaction that include the persisting smart contract may be required to have the same value as the outputs (UTXOs) that that include the persisting smart contract spent by the inputs of that transaction.

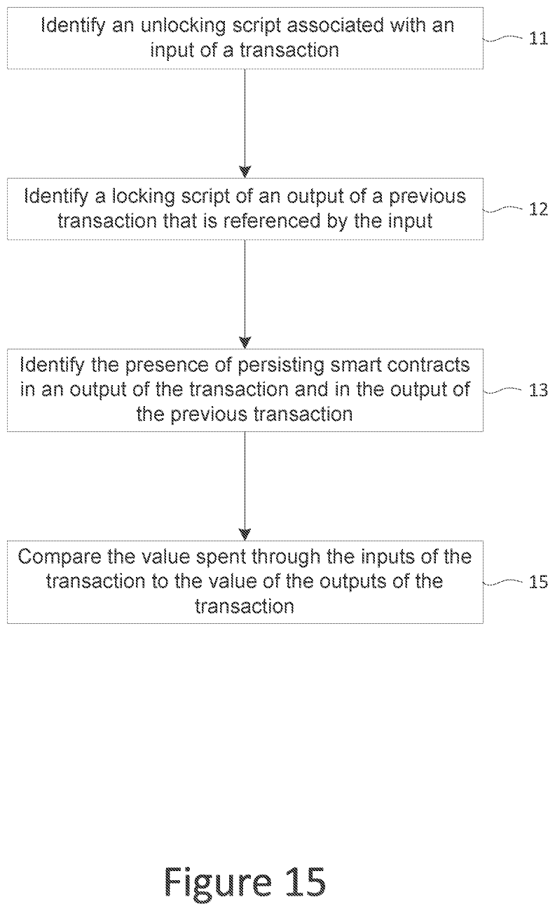

Therefore, referring to FIG. 15, in a fifth step 15 (that may occur with or without the fourth step 14), the validating node may be arranged to compare the value of the outputs spent through the inputs of the transaction to the value of the outputs of the transaction.

The transaction may then be validated in dependence on the value of the outputs spent through the inputs being equal to the value of the outputs.

As described above, in some embodiments it is desirable to ensure that only a single input of a transaction corresponds to an output of the previous transaction that is associated with a locking script comprising the persisting smart contract. This is typically required for straightforward token spending without spending necessarily involving multiple inputs.

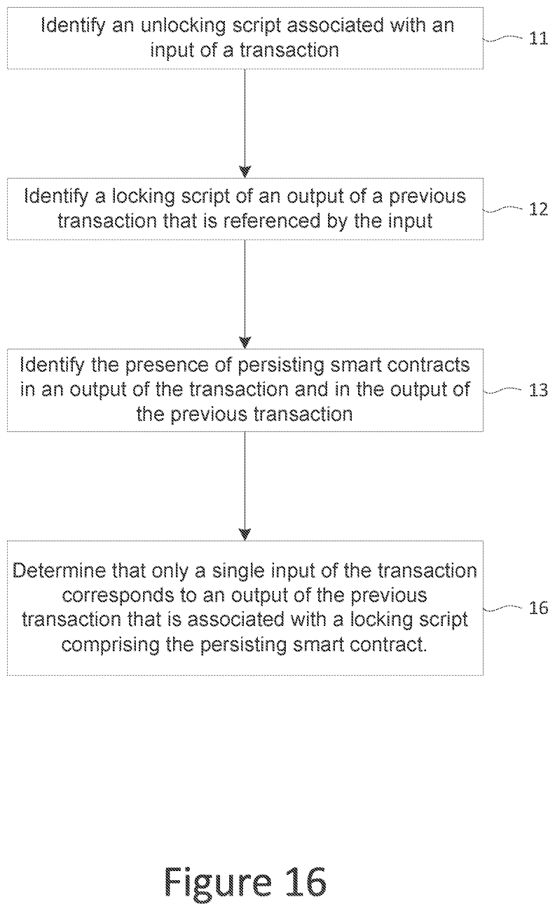

Therefore, referring to FIG. 16, in a sixth step 16 (that may occur with or without the fourth step 14 and the fifth step 15), the node determines that only a single input of the transaction references an output of a previous transaction that is associated with the persisting smart contract (e.g. a locking script comprising the persisting smart contract).

The transaction may then be validated in dependence on there being only a single input that references an output comprising the persisting smart contract.

For implementation simplicity, this single input may be the first input of the transaction (where this may be required by the locking script).

### Atomic Swaps

One of the benefits of the persisting smart contract described herein is that it enables the provision of atomic swaps, in which assets are swapped between parties essentially simultaneously (e.g. in a single transaction). This use of the persisting smart contract enables these swaps to be achieved without requiring the locking of either of the assets before the swap.

Therefore, the transaction (e.g. the inputs and/or outputs of the transaction) may define a swap of assets between two parties. More specifically, the transaction may define a swap of an asset referenced in a first input of the transaction for an asset referenced in a second input of the transaction.

As described above, where such a swap occurs, any persisting smart contracts associated with the inputs must be replicated to the locking scripts of the opposite outputs. That is, a first persisting smart contract associated with the first input should be replicated in a locking script of the second output and/or a second persisting smart contract associated with the second input should be replicated in a locking script of the first output.

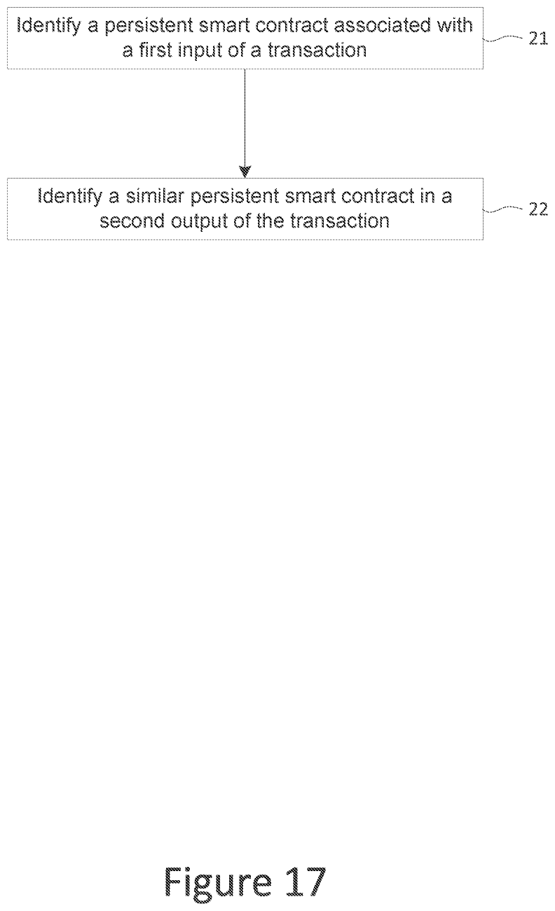

Therefore, referring to FIG. 17, where a transaction comprises a first input and a second input and a first output (corresponding to the first input), and a second output (corresponding to the second input), a node (e.g. a validating node) of the blockchain may:

In a first step 21, identify a persisting smart contract associated with a first input of a transaction (e.g. the persisting smart contract may be included in the locking script of an output referenced by this first input).

In a second step 22, identify a similar persisting smart contract in a second output (e.g. in a locking script of the second output) of the transaction.

The node may then validate the transaction in dependence on the presence of the similar persisting smart contract in the second output.

The first input and the second input may relate to different types of assets, so that this method of swapping enables the exchange of these assets. Typically one (or both) of the assets comprises a substantiated token, so that the swap relates to the swap of assets associated with these substantiated tokens.

Where each input is associated with a substantiated token (and/or with a persisting smart contract), the method further comprises the node (e.g. a validating node) identifying a persisting smart contract in the first output of the transaction, where this persisting smart contract is similar to a persisting smart contract that is present in the output referenced by the second input of the transaction.

As described above, the method may differ depending on whether the swap relates to substantiated tokens or unsubstantiated tokens, therefore the method may comprise determining a type of swap associated with the transaction, e.g. whether the swap relates to substantiated tokens or to unsubstantiated tokens.

In order to perform the swap, a party that holds an asset provides a transaction with a first input that references this asset and a first output (corresponding to the first input) that indicates a desired return for which the party is willing to swap the asset.

In particular with unsubstantiated tokens, the party proposing the swap signs the first input (e.g. using a SINGLE|ANYONECAN PAY flag), and then transmits the transaction to another party. This other party completes the remainder of the transaction (e.g. fills in the second input and the second output as well as, optionally, a funding input and a corresponding optional change output) and then signs each of the remaining inputs of the transaction.

The other party includes in the locking script of the second output the persisting smart contract associated with the first input. In this way, the persisting smart contract continues to persist throughout (transactions of) the blockchain and continues to be associated with the relevant tokens.

To enable the provision of multiple bids (e.g. an auction where other parties are bidding for the asset that is referenced by the first input), the transaction may be associated with an earliest acceptance time (e.g. a nLocktime) that is in the future when the transaction is transmitted. Similarly, an input of the transaction may be associated with a sequence number that is less than a maximum sequence number (e.g. an nSequence of less than 0xFFFFFFFF). Therefore, the transaction cannot be recorded on the blockchain till the earliest acceptance time has passed (another party cannot set all inputs of the transaction to have the maximum sequence number so as to record the transaction before this time).

Therefore, different parties are able to make different bids (or offers) by completing multiple partial transactions of the proposer and transmitting them to the blockchain, where these proposed partial transactions have both increasing requested asset amounts (in their first output) along with increasing nSequence number (in their first input). Eventually, when the nLocktime arrives, the transaction with the highest nSequence number will be included in the blochchain by validating nodes, while discarding all the others.

In particular with substantiated tokens, the party proposing the swap may not sign the first input. Therefore, the transaction cannot be recorded by another party. The party proposing the swap waits until another party has transmitted a transaction that has a signed second input and second output (where this second input and output define an offer). If the offer is sufficient, the party proposing the swap signs the first input and the first output to form a valid transaction that can be recorded on the blockchain. This method can be used with both single-offer swaps (where the offer price is known) and auction swaps. For auction swaps, the party offering the swap receives multiple offers in the form of multiple transactions with signed second inputs and outputs and this party then selects one of these multiple offers and signs the transaction relating to this selected offer. This signed transaction can then be transmitted to a node of the blockchain and thereafter included in a block of the blockchain.

### Alternatives and Modifications

Various other modifications will be apparent to those skilled in the art. For example, while the detailed description has primarily considered the disclosed methods being used with a Bitcoin-based blockchain, it will be appreciated that these methods are more generally applicable to any UTXO based blockchain.

It will be understood that the present invention has been described above purely by way of example, and modifications of detail can be made within the scope of the invention.

Reference numerals appearing in the claims are by way of illustration only and shall have no limiting effect on the scope of the claims.

1. A computer-implemented method of outputting a transmission to a second node of an unspent transaction output (UTXO) based blockchain, the method being performed by a first node of the blockchain, the method comprising:
identifying an input of a transaction;
identifying a locking script associated with an output of a previous transaction that is referenced by the input, wherein the locking script comprises a persisting smart contract that is arranged to persist through multiple transactions on the blockchain; and
outputting a transmission to the second node in dependence on:
the persisting smart contract being present in a locking script of an output of the transaction; and/or
a redemption condition of the persisting smart contract being satisfied;
wherein the persisting smart contract comprises a token identifier; and
wherein the token identifier is associated with a contract transaction, which contract transaction is associated with the persisting smart contract, wherein the contract transaction defines the redemption condition.

2. The method of claim 1, wherein the contract transaction is a parent transaction of an issuing transaction and/or wherein the identifier comprises a public key and/or an address associated with a locking script of a UTXO that is spent by the issuing transaction.

3. The method of claim 1, wherein the token identifier comprises a public key and/or an address from the issuing transaction and/or the contract transaction and/or wherein the token identifier comprises an address from a locking script of the contract transaction.

4. The method of claim 1, wherein the token identifier comprises an immutable identifier.

5. The method of claim 1, wherein the locking script requires the presence of the persisting smart contract in an output of the transaction unless the redemption condition is satisfied.

6. The method of claim 1, wherein the persisting smart contract restricts a usage of a UTXO and/or token associated with the persisting smart contract.

7. The method of claim 1, wherein the persisting smart contract:
limits the use of a substantiated token associated with the persistent smart contract; and/or
defines a redemption address and/or a redemption public; and/or
defines a representation of the token, preferably wherein the contract transaction defines a representation of the token that is associated with an asset that is external to the blockchain.

8. The method of claim 1, comprising determining a parameter of the transaction; and outputting the transmission in dependence on the parameter and the persisting smart contract.

9. The method of claim 1, wherein the contract transaction defines an issuance contract and/or wherein the issuance contract defines requirements and/or conditions for the spending of the token.

10. The method of claim Error! Reference source not found., wherein an output of the contract transaction comprises an operation code that marks a transaction output execution termination, wherein this transaction output comprises the issuance contract.

11. (canceled)

12. The method of claim 1, wherein the token identifier comprises one or more of:
an identifier of an issuer of a substantiated token; and
a public key and/or an address associated with an issuer of a substantiated token.

13. The method of claim 1, wherein:
the locking script requires as an unlocking condition:
that the persisting smart contract is replicated in a locking script of an output of the transaction, preferably an output corresponding to the input; and/or
that a redemption condition set by a/the contract transaction is satisfied;
a redemption condition set by a/the contract transaction is satisfied.

14. The method of claim 1, comprising identifying an ownership indicator associated with the persisting smart contract.

15. The method of claim 1, wherein the locking script and/or the persisting smart contract requires as an unlocking condition that the value of the outputs spent through the inputs of the transaction is equal to the value of the outputs of the transaction.

16. The method of claim 1, comprising comparing the value of the outputs spent through the inputs of the transaction to the value of the outputs of the transaction, outputting a transmission to the second node in dependence on the value of the outputs spent through the inputs of the transaction being equal to the value of the outputs.

17. (canceled)

18. The method of claim 16, comprising comparing the value of the outputs spent through the inputs of those transactions associated with the persisting smart contract to the value of the outputs of those transaction associated with the persisting smart contract;

19. The method of claim 1, wherein identifying the input comprises identifying an input with a predetermined index, preferably identifying an input with an index of zero.

20. The method of claim 1, comprising determining that only a single input of the transaction references an output of a previous transaction that is associated with a locking script comprising the persisting smart contract, preferably comprising determining an index of said single input of the transaction, preferably outputting a transmission to the second node in dependence on the index having a predetermined value.

21.-55. (canceled)

56. A computer-implemented method of configuring an unspent transaction output (UTXO) based blockchain so that in order to validate a transaction for inclusion in the blockchain a node is required to:
identify an input of a transaction;
identify a locking script associated with an output of a previous transaction that is referenced by the input, wherein the locking script comprises a persisting smart contract that is arranged to persist through multiple transactions on the blockchain; and
output a transmission to the second node in dependence on:
the persisting smart contract being present in a locking script of an output of the transaction; and/or
a redemption condition of the persisting smart contract being satisfied;
wherein the persisting smart contract comprises a token identifier; and
wherein the token identifier is associated with a contract transaction, which contract transaction is associated with the persisting smart contract, wherein the contract transaction defines the redemption condition.

57. (canceled)

58. (canceled)

59. An unspent transaction output (UTXO) based blockchain comprising a block, wherein the block comprises a transaction, and wherein:
an input of the transaction references an output of a previous transaction that comprises a locking script, wherein the locking script comprises a persisting smart contract that is arranged to persist through multiple transactions on the blockchain;
wherein the locking script requires, as an unlocking condition, that:
the persisting smart contract being present in a locking script of an output of the transaction; and/or
a redemption condition of the persisting smart contract being satisfied;
wherein the persisting smart contract comprises a token identifier; and
wherein the token identifier is associated with a contract transaction, which contract transaction is associated with the persisting smart contract, wherein the contract transaction defines the redemption condition.

60. (canceled)

61. (canceled)
